(19) United States
(12) Patent Application Publication
(10) Pub. No.: US 2026/0322765 A1
(43) Pub. Date: Oct. 15, 2026

(54) TELECOMMUNICATIONS PROCESSOR INCLUDING A RECONFIGURABLE INTERCONNECT DEVICE

(71) Applicant: THALES, Meudon (FR)

(72) Inventor: Yann Oster, Toulouse (FR)

(21) Appl. No.: 19/408,194

(22) Filed: Dec. 3, 2025

(30) Foreign Application Priority Data
Dec. 4, 2024 (FR) 24 13423

(51) Int. Cl. H04L 49/104; H04B 7/0426; H04L 49/15

(52) U.S. Cl. CPC H04L 49/106; H04B 7/043; H04L 49/1576

(57) ABSTRACT

The invention relates to a telecommunications processor which comprises a reconfigurable non-blocking interconnection device, configured to receive on inputs signals from one or more receiving antennas and to deliver via outputs said signals to one or more transmitting antennas. The interconnection device comprises a crossbar switch forming a two-dimensional array of rows and columns, and comprising a number of elementary switches less than the number of row-column intersections of the two-dimensional array, for routing said signals from inputs to outputs. The elementary switches are arranged at row-column intersections to form at least one triangular matrix, such that all the row-column intersections in the triangular matrix have an elementary switch that can be activated, and such that all or some of the row-column intersections located outside the triangular matrix do not have an elementary switch.

This patent application claims the benefit of document FR 24/13423 filed on Dec. 4, 2024 which is hereby incorporated by reference.

### FIELD

The disclosure relates to a telecommunications processor comprising a reconfigurable interconnection device and a method of configuring the processor in accordance with the disclosure.

### BACKGROUND

FIG. 1 illustrates an example of a telecommunications processor in the prior art. Typically, a telecommunications processor 1000 comprises input ports Rx and output ports Tx connected to radio frequency (RF) or optical reception or transmission channels.

The ports Rx (respectively Tx) are associated with receiving (respectively transmitting) antennas, to provide a link with fixed relay stations, known as gateways (GW), on the one hand, and users (fixed or mobile) on the other. The antennas used for transmitting to or receiving from users may be active antennas (antenna arrays or phased-array systems) made up of a set of elementary antenna elements whose signals can be combined according to a configurable beamforming algorithm, enabling flexible formation of beams in the desired directions.

The receive or transmit chains are connected to RF antennae or optical transmission devices respectively. For example, the receive or transmit chains process optical signals when the telecommunications system comprising the processor uses free-space optical links.

At the input ports Rx and output ports Tx, signals can be received, respectively transmitted, simultaneously from, or to, a set of different directions, depending on the pattern of the antenna(s) associated with the port. The signals generally comprise frequency channels in which the transmitted information is encoded.

An RF signal can be received by an antenna or antenna array. The electrical signal received is generally processed (in receiver chains) in analogue form to pre-filter the frequency band, to amplify it, or to carry out a frequency conversion in order to shift the useful band around an intermediate frequency. In particular, in a digital processor, the signal is then converted into a digital signal by analogue-to-digital converters ADC. The received signal can also undergo additional digital frequency filtering. Received and digitised signals can be broken down into their elementary frequency components using demultiplexers Dx. The frequency components produced by the demultiplexers can be processed by a beamformer DBF-RX.

RF signals can be spatially filtered in specific directions due to the specific geometry of the antenna(s) (such as RX/GW).

Alternatively, beams can be produced using a set of elementary antennas with associated signal processing. This beamforming processing can be carried out in analogue form, in particular in an analogue telecommunications processor, or in digital form, in particular in a digital telecommunications processor.

The shaped signals are then routed to the input ports of an interconnection device 110. The signals supplied by the interconnection device 110 may be processed by a transmit beamformer DBF-TX. Then, multiplexers Mx compose the signals either directly at the output of the interconnection device 110 or at the output of the beamformer DBF-TX.

Compound signals are converted into analogue signals by digital-to-analogue converters DAC, before being amplified (in transmitter chains) for transmission by transmitting antennas (TX.GW, antenna array).

The interconnection device 110 implements a function for routing signals received at its inputs to produce them at its outputs. The interconnection device is reconfigurable to select the output(s) associated with the various inputs. The interconnection device 110 therefore provides flexible connectivity between the upstream receive channels and the downstream transmit channels. A channel is considered as a resource in terms of direction and in terms of frequency sub-bands, and is associated with a useful signal (for a user or for a gateway station), whether in transmission or in reception.

And by virtue of its position at the core of the processor, the interconnection device handles all data traffic. In particular, the digital throughput processed by the interconnection device 110 is proportional to the total aggregated bandwidth (which depends on the number of beams and the average bandwidth per beam, for example on the order of several hundred GHz) and on the quantisation used for the digital signals (for example, 16-bit).

The interconnection device is typically arranged in routing rows and columns. Switches at the intersections of rows and columns allow a signal to be routed from a row to a column or vice versa. Depending on its architecture, in other words the arrangement of the switches, an interconnection device may be capable of routing a signal from any of its inputs to any one or more of its outputs, independently of the rows and columns already connected. In particular, an interconnection device is said to be “blocking” if it does not have this property. The interconnection device is described as “conditionally non-blocking” if it can implement any new interconnection on condition that the connections of the already-established rows and columns are reconfigured. Finally, the interconnection device is said to be “strictly non-blocking” if it can implement any interconnection without reconfiguring the rows and columns already established.

When an input delivers its signal to a single output, this is known as a unicast connection. When an input delivers its signal to several outputs, this is known as a multicast connection. In particular, in an application where the processor is on-board a satellite, the multicast connection is used to simultaneously broadcast the same information to several recipients, who are in particular visible from different directions and/or use different frequency channels.

A reconfigurable interconnection device with a simple architecture is a crossbar switch, for example shown in FIG. 2. The crossbar switch example forms a square two-dimensional array (or matrix) with N rows and N columns. The crossbar switch includes elementary switches at the intersections of the rows and columns (not illustrated). A connection between a row and a column is achieved in particular by passing the switch located at the intersection of this row and this column.

More generally, a reconfigurable interconnection device of the crossbar switch type has a rectangular architecture comprising N rows and P columns.

In the context of the present application, and for the sake of simplifying the description rather than limiting it, one dimension of the network designates a direction along which either the rows or the columns are positioned.

The inputs of the crossbar switch are located in a first dimension and the outputs of the crossbar switch are located in a second dimension. In the example shown in FIG. 2, the first dimension is that along which the rows are positioned, and the second dimension is that along which the columns are positioned. However, the reverse is also possible.

In the simplified example of a square array shown in FIG. 2, the inputs of the crossbar switch are located along the left-hand side of the square array and the outputs of the crossbar switch are located along the bottom side of the square array. However, the entrances and exits could be positioned on other sides of the square array.

The elementary switches located at the line-column intersections can be 1×1 switches, for example as shown in FIG. 3. A 1×1 switch has an input and an output and selectively establishes the connection between its input and its output. In an integrated electronic circuit, a 1×1 switch can be implemented by a FET transistor. In a manner known per se, the configuration of the crossbar switch using 1×1 switches must guarantee the absence of signal contention, i.e. the impossibility for several inputs to transmit their inputs to the same output. Thus, in particular, when several rows are driven at low impedance at the input, each column of the crossbar switch has at most a single closed 1×1 switch.

The elementary switches can be 2×1 switches, also known as multiplexers, for example as shown in FIG. 4. A 2×1 multiplexer has two inputs and one output and selectively establishes the connection between its first input or its second input and its output. For example, in FIG. 4, each 2×1 multiplexer selects the signal present on its line input or that on its column input, and propagates it to its column output. The 2×1 multiplexer avoids any risk of contention between line inputs.

A crossbar switch is particularly advantageous in that it is non-blocking for unicast or multicast connections. However, the implementation complexity and power consumption of a crossbar switch are quadratic with its number of inputs/outputs.

A rectangular crossbar switch with N rows and P columns, consisting of a full matrix network, i.e. with an elementary switch at each row-column intersection, has a complexity in terms of elementary switches of N*P.

If the switch is a square matrix array (N=P), the number of elementary switches is N2.

However, the digital throughput and the number of inputs/outputs supported by current telecommunications processors tend to increase. This is particularly significant in applications where the telecommunications processor is carried on board a satellite.

A solution is therefore sought to the problem of both the implementation complexity and the power consumption of a reconfigurable interconnection device for a telecommunications processor.

To this end, the disclosure proposes a specific arrangement of the elementary switches of the crossbar switch, combined with a permutation of the beam-forming algorithms of the upstream or downstream signals of the array, or combined with a permutation of the signals upstream of the crossbar switch.

The assembly of elementary switches for a crossbar switch defines a partial square or rectangular matrix network, where no elementary switches are implemented within at least one triangular matrix so as to define at least one triangular matrix of active switches in the array.

This reduces the complexity of elementary switches. Implementing a permutation of the beam-forming algorithms upstream or downstream of the matrix array, or a permutation of the signals upstream of the matrix array, makes it possible to guarantee the establishment of any unicast or multicast connection by the reconfigurable interconnection device of the crossbar-switch type, whose architecture comprises N rows and P columns.

In order to configure signal routing, by applying specific permutations upstream or downstream of the crossbar switch, in an appropriate manner with a specific configuration of elementary switches organised according to at least one triangular matrix, the present disclosure makes it possible to reduce the complexity of the number of switches to be implemented.

In the case of a square array where N=P, the complexity in terms of the number of elementary switches is reduced to N(N+1)/2.

Due to the absence of elementary switches at line-column intersections which are not located within such at least one triangular matrix, the device of the disclosure allows a significant reduction in the consumption of the crossbar switch.

### SUMMARY OF CERTAIN INVENTIVE ASPECTS

To achieve the desired result, a telecommunications processor is proposed comprising a reconfigurable non-blocking interconnection device, configured to receive on inputs signals from one or more receiving antennas and to deliver said signals via outputs to one or more transmitting antennas. The interconnection device comprises a crossbar switch forming a two-dimensional array of N rows and P columns, the inputs of the crossbar switch being located along a first dimension of the array, the outputs of the crossbar switch being located along a second dimension of the array. The crossbar switch comprises a number of elementary switches smaller than the number of line-column intersections of the two-dimensional network, to route said signals from the inputs to the outputs. The elementary switches are arranged on the array at the row-column intersections so as to form at least one triangular matrix, such that all row-column intersections within said at least one triangular matrix comprise an elementary switch that can be activated, and such that all or some of the row-column intersections located outside said at least one triangular matrix do not comprise an elementary switch.

The device can be implemented in an alternative or combined mode.

In one embodiment, the interconnection device is coupled to a permutation device enabling the input or output signals of said at least one triangular matrix to be permuted.

In one embodiment, the telecommunications processor comprises receive beamformers associated with beamforming algorithms, and the permutation device is configured to permute one or more beamforming algorithms between the beamformers, so as to permute the signals upstream of said at least one triangular matrix, depending on the routing required between the upstream signals and the downstream signals of the configurable interconnection device.

In one embodiment, the telecommunications processor comprises transmit beamformers associated with beamforming algorithms, and the permutation device is configured to permute one or more beamforming algorithms between the beamformers, so as to permute the downstream signals of said at least one triangular matrix, depending on the routing required between the upstream signals and the downstream signals of the configurable interconnection device.

In one embodiment, the two-dimensional array of N rows and P columns forms a square matrix array with N=P or forms a rectangular matrix array with N±P.

In one embodiment, the elementary switches forming at least one triangular matrix are 1×1 switches or 2×1 switches.

In one embodiment, the elementary switches forming at least one triangular matrix are 2×2 switches configured to selectively interconnect a first input along the first dimension or a second input along the second dimension with a first output along the first dimension and independently with a second output along the second dimension.

In one embodiment, the elementary switches on the diagonal of said at least one triangular matrix are successively connected to each other, by connecting the row output of each switch to the column input of the next switch on the diagonal.

In one embodiment, the permutation device comprises a switch connected upstream of the crossbar switch, said switch being configured to distribute the signals among the inputs of the crossbar switch according to the routing required between the upstream signals and the downstream signals of the configurable interconnection device.

The disclosure also concerns processes.

In one embodiment, the disclosure relates to a method of configuring a telecommunications processor which comprises, for signal routing, steps consisting of:
determining a set of pairs (i, j) corresponding to a routing requirement between signals upstream and signals downstream of the interconnection device, considering all the line-column intersections of the crossbar switch array;
determining elementary switches of said at least one triangular matrix to be activated for said routing, said step consisting of:
   i. organising said pairs (i, j) into rank groups having the same rank along the first dimension;
   ii. determining an extremum rank in the second dimension for each rank group;
   iii. ordering said rank groups according to their extremum rank along the second dimension;
   iv. successively allocating to each ranked group a rank along the first dimension of the array, following the order obtained from said scheduling step, starting with the rank along the first dimension that forms one side of the triangular matrix;
   v. for each group of ranks, transposing each pair (i, j) into a pair (allocated rank, j), and activating the elementary switch of said pair (allocated rank, j);
permuting the signals at the input of the crossbar switch, in accordance with the rank allocation.
   In one embodiment, the step of determining the elementary switches to be activated consists of:
   i. organising said pairs (i, j) into rank groups having the same rank along the first dimension;
   ii. determining a minimum rank in the second dimension for each rank group;
   iii. ordering said rank groups in ascending order of minimum rank along the second dimension.
      In one embodiment, the step of determining the elementary switches to be activated consists of:
   i. organising said pairs (i, j) into rank groups having the same rank along the first dimension;
   ii. determining a maximum rank in each rank group according to the second dimension;
   iii. ordering said rank groups in descending order of maximum rank along the second dimension.

In one embodiment, the disclosure relates to a method of configuring a telecommunications processor which comprises, for signal routing, steps consisting of:
determining a set of pairs (i, j) corresponding to a routing requirement between signals upstream and signals downstream of the interconnection device, considering all the line-column intersections of the crossbar switch array;
determining elementary switches of said at least one triangular matrix to be activated for said routing, said step consisting of:
   i. organising said pairs (i, j) into rank groups having the same rank along the first dimension;
   ii. ordering said rank groups according to their rank along the first dimension;
   iii. successively allocating to each ranked group a rank along the second dimension of the array, starting with the rank along the second dimension that forms one side of the triangular matrix;
   iv. within each ranked group, for each pair, transposing the pair (i, j) into the pair (i, allocated rank), activating the elementary switch of the pair (i, allocated rank), and storing the rank j along the second dimension for the allocated rank;
summing the beam-forming algorithms corresponding to the ranks along the second dimension that are stored for the same allocated rank associated with a transmit beamformer;
permuting the output signals of the beamformers downstream of the crossbar switch by permuting the assignment of the algorithms to the beamformers, in accordance with the rank allocation.
   In one embodiment, the step of determining the elementary switches to be activated consists of:
   i. organising said pairs (i, j) into rank groups having the same rank along the first dimension;
   ii. ordering said ranked groups in ascending order of rank along the first dimension.
      In one embodiment, the step of determining the elementary switches to be activated consists of:
   i. organising said pairs (i, j) into rank groups having the same rank along the first dimension;
   ii. ordering said ranked groups in descending order of rank along the first dimension.

### BRIEF DESCRIPTION OF THE DRAWINGS

Further features and advantages of the present disclosure will become apparent from the following description in relation to the following appended figures:

FIG. 1, already described, shows a telecommunications processor according to the prior art;

FIG. 2, already described, shows a crossbar switch according to the prior art;

FIG. 3, already described, shows a crossbar switch according to the prior art comprising 1×1 switches;

FIG. 4, already described, shows a crossbar switch according to the prior art comprising 2×1 switches;

FIG. 5 shows the architectures of a crossbar switch of a reconfigurable interconnection device in a processor according to the disclosure;

FIG. 6 illustrates a first example of a process for configuring a telecommunications processor according to the disclosure;

FIG. 7 illustrates a second example of a process for configuring a telecommunications processor according to the disclosure;

FIG. 8 illustrates a third example of a process for configuring a telecommunications processor according to the disclosure;

FIG. 9 illustrates a fourth example of a process for configuring a telecommunications processor according to the disclosure;

FIG. 10 illustrates a fifth example of a process for configuring a telecommunications processor according to the disclosure;

FIG. 11 illustrates a sixth example of a process for configuring a telecommunications processor according to the disclosure;

FIG. 12 illustrates a seventh example of a process for configuring a telecommunications processor according to the disclosure;

FIG. 13 illustrates an eighth example of a process for configuring a telecommunications processor according to the disclosure;

FIG. 14 illustrates a ninth example of a process for configuring a telecommunications processor according to the disclosure;

FIG. 15 illustrates a tenth example of a process for configuring a telecommunications processor according to the disclosure;

FIG. 16 illustrates an eleventh example of a process for configuring a telecommunications processor according to the disclosure;

FIG. 17 illustrates a variant of a first embodiment of a telecommunications processor according to the disclosure;

FIG. 18 illustrates a second embodiment of a telecommunications processor according to the disclosure;

FIG. 19 shows the second embodiment of a telecommunications processor according to the disclosure;

FIG. 20 illustrates an example of a Clos network in a third embodiment of a telecommunications processor according to the disclosure;

FIG. 21 illustrates another example of a Clos network in the third embodiment of a telecommunications processor according to the disclosure;

FIG. 22 illustrates an example of a telecommunications processor according to the disclosure;

FIG. 23 illustrates another example of a telecommunications processor according to the disclosure;

FIG. 24 illustrates yet another example of a telecommunications processor according to the disclosure;

FIG. 25a illustrates a general case of permutations upstream of the matrix network according to the disclosure;

FIG. 25a illustrates a general case of permutations upstream of the matrix array according to the disclosure;

FIG. 26 illustrates an example of downstream permutations of the matrix array according to the disclosure.

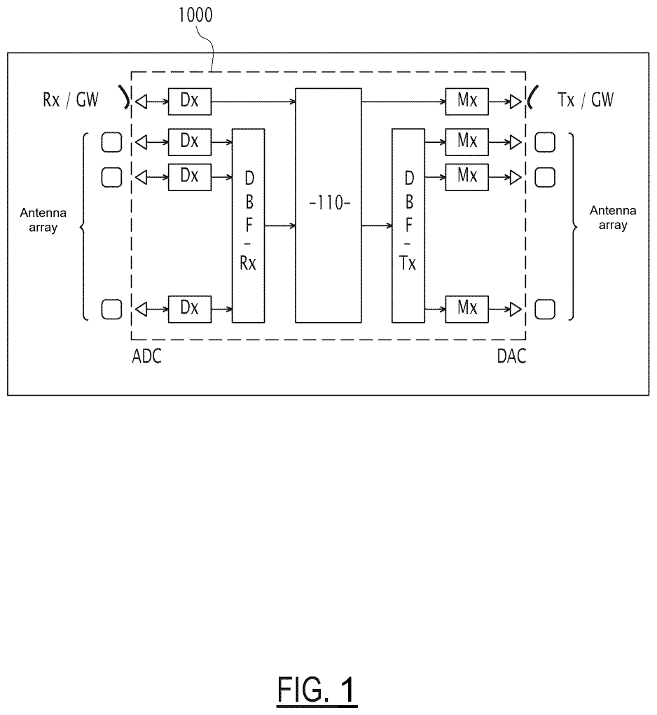

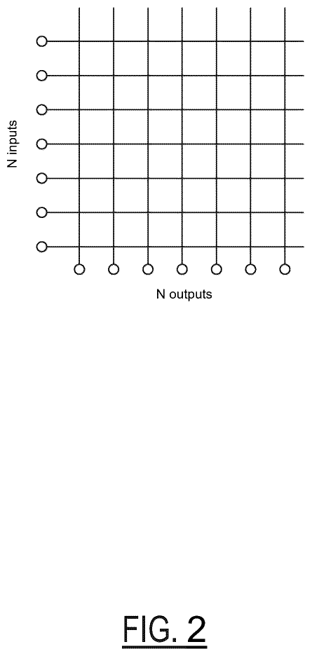

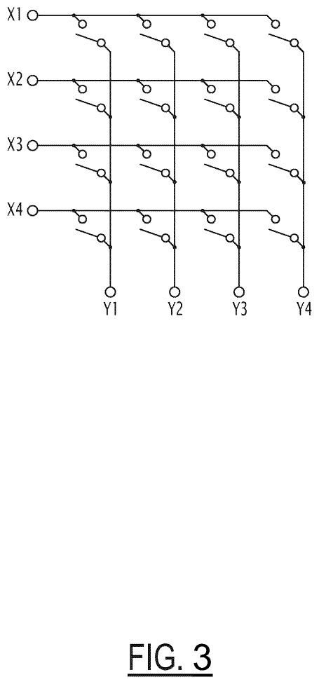

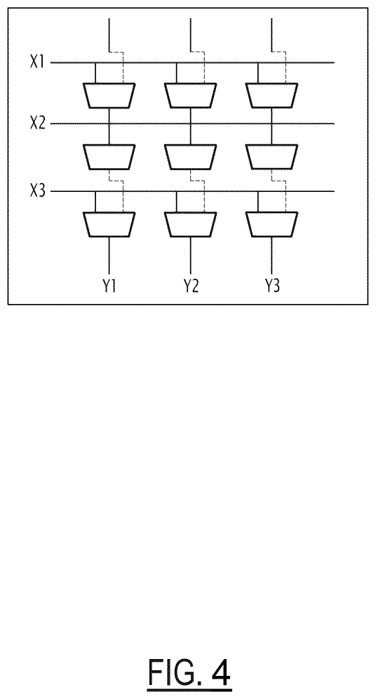

### DETAILED DESCRIPTION

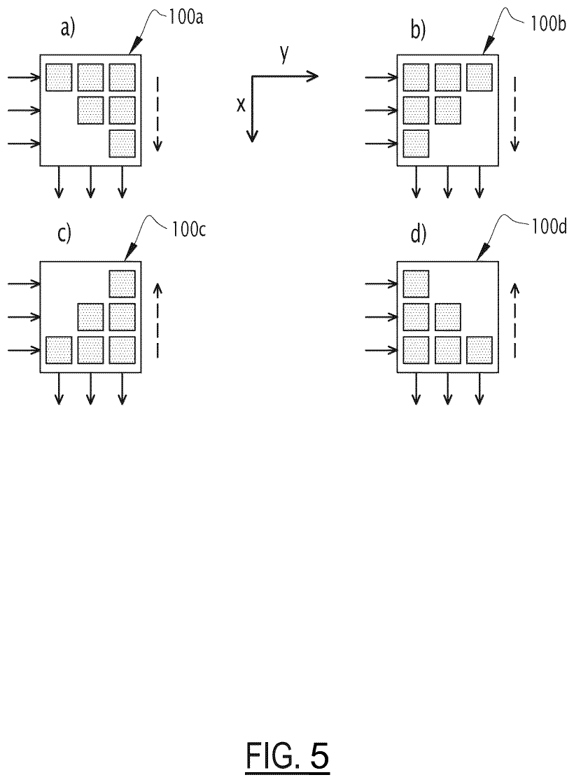

FIG. 5 illustrates examples of crossbar switches (100a, 100b, 100c or 100d) for a reconfigurable interconnection device of a telecommunications processor according to the disclosure, in a particular example of switches of the square array type. The telecommunications processor is typically made, for example, with a set of interconnected electronic integrated circuits distributed over a set of printed circuits. The reconfigurable interconnect device receives signals corresponding to frequency sub-bands from one or more receiving antennas and delivers the signals to one or more transmitting antennas.

The crossbar switch (100a, 100b, 100c or 100d) forms a square array of rows and columns. In generic terms, a crossbar switch according to the disclosure will be referenced as 100. Elementary switches located at the row-column intersections of the array connect the rows and the columns. The arrangement of the elementary switches making up the crossbar switch according to the disclosure forms a triangular matrix.

A triangular matrix is an arrangement of elementary switches located in particular on a diagonal and on one side of the diagonal of the array. The diagonal of the array may be the one linking the upper-left corner of the array to the lower-right corner (illustrated by 100a and 100d), also referred to as the “main diagonal”; or the one linking the upper-right corner of the array to the lower-right corner (illustrated by 100b and 100c), also referred to as the “antidiagonal.” Advantageously, according to the arrangement of the device of the disclosure, all the line-column intersections of the triangular matrix comprise an elementary switch which can be made active to route signals.

The inputs of the crossbar switch 100a, 100b, 100c, 100d are located along a first dimension X of the row-column array. The outputs of the crossbar switches 100a, 100b, 100c and 100d are located along a second dimension Y of the row-column array. In the figures illustrating the examples according to the disclosure, the first dimension X is that along which the rows are positioned, and the second direction Y is that along which the columns are positioned. In other words, the inputs are on the rows and the outputs are on the columns. However, the reverse is also possible. In addition, in the figures, the inputs of the crossbar switch are located along a left-hand side of the square array; and the outputs of the crossbar switch are located along a bottom side of the square array. However, the entrances and exits could be positioned on other sides of the square array. The characteristics of other examples of the disclosure, in which, with respect to the figures, the first dimension and the second dimension are different and/or the inputs and outputs are located on other sides of the network, can be easily deduced on the basis of the present description.

In a first architecture 100a shown in view a) of FIG. 5, the elementary switches form an upper triangular matrix along the main diagonal, with the inputs of the crossbar switch extending along the left side of the square array and the outputs of the crossbar switch extending along the bottom side of the square array.

In a second architecture 100b shown in view b) of FIG. 5, the elementary switches form an upper triangular matrix along the anti-diagonal, with the inputs of the crossbar switch extending along a left side of the square array and the outputs of the crossbar switch extending along a bottom side of the square array.

In a third architecture 100c shown in view c) of FIG. 5, the elementary switches form a lower triangular matrix following the anti-diagonal, with the inputs of the crossbar switch extending along a left side of the square array and the outputs of the crossbar switch extending along a lower side of the square array.

In a fourth architecture 100d shown in view d) of FIG. 5, the switch elements form a lower triangular matrix along the main diagonal, with the crossbar switch inputs extending along a left side of the square array and the crossbar switch outputs extending along a bottom side of the square array.

In a connection between its inputs and outputs, the crossbar switch 100a, 100b, 100c or 100d uses only the elementary switches located at the row-column intersections of the array forming a triangular matrix. The other intersections in the row-column array can then be free of elementary switches, making it easier to implement the crossbar switch. In addition, the reduction in the number of elementary switches compared with the prior art and, consequently, the reduction in the number of communication links within the crossbar switch, makes it possible to reduce its power consumption compared with the prior art.

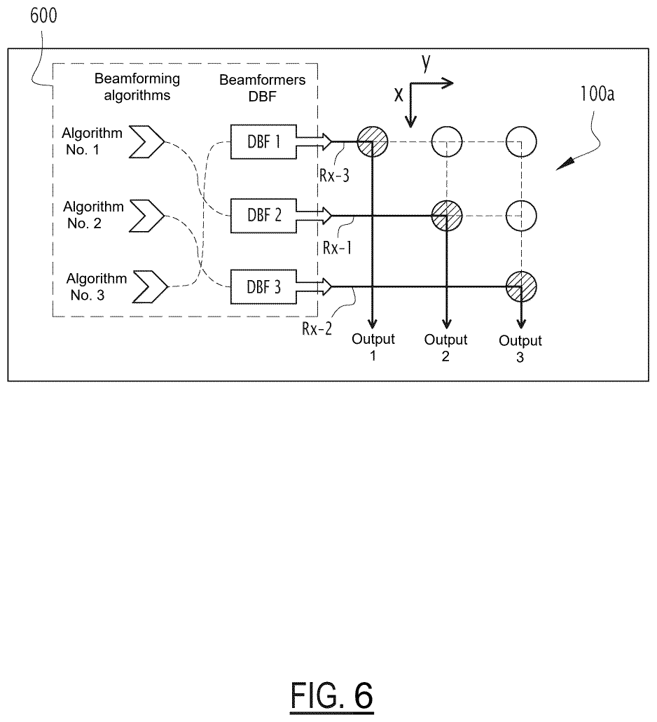

In a first embodiment illustrated in FIGS. 6 to 17, the non-blocking nature of the crossbar switch is achieved by means of a permutation device coupled to switch 100. Depending on a given configuration of the connections to be made between the signals upstream and the signals downstream of the crossbar switch, the permutation device, generally referred to as 600, enables the beam-forming algorithms to be permuted. Permutations can be performed either upstream of the triangular matrix array or downstream. In this way, the permutation device 600 allows the routing requirement within the crossbar switch to be adjusted to mobilise only elementary switches within a fixed triangular assembly, thereby relaxing the required number of elementary switches. The arrangement of the elementary switches in a triangular matrix associated with the permutation device ensures the non-blocking nature of the crossbar switch according to the first design mode, as well as the possibility for it to provide unicast and multicast connections.

In a first variant of the first embodiment illustrated in FIGS. 6 to 16, the permutation device 600 comprises digital beamformers (DBFs). The receive beamformers DBF are located upstream of the reconfigurable interconnection device, and therefore upstream of the crossbar switches 100a, 100b, 100c and 100d. In a manner known in itself, each beamformer DBF1, DBF2 and DBF3 generates one of the signals Rx-1, Rx-2 and Rx-3 from the signals originating from the elementary antennas of the receive antenna array, based on a beamforming algorithm. The signals Rx-1, Rx-2, Rx-3 correspond to the radio frequency signals received in the beam directions defined by the formation algorithms Algorithm No. 1, Algorithm No. 2, Algorithm No. 3, configured in the trainers, which must then be transmitted by one or more transmitting antennas.

In this first variant of the first embodiment, the beam-forming algorithms may be permuted according to the configuration of the connections to be established between the upstream and downstream signals of the crossbar switches 100a, 100b, 100c and 100d. Thus, routing of the signals, in particular the beams, through the crossbar switch 100a, 100b, 100c, 100d can be obtained by activating the elementary switches in a configuration adapted to the constraints of the triangular arrangement of the elementary switches, then by permuting the beamforming algorithms so as to modify the distribution of the signals Rx-1, Rx-2, Rx-3 between the inputs of the crossbar switch. In this first variant, the receive beamformers, which are also present in the telecommunications processor, are used as a permutation device. This optimises switching resources in the telecoms processor.

FIGS. 6 to 10 show examples of a process for configuring a processor according to the first variant of the first embodiment with the first architecture 100a. In particular, a first beamformer DBF1 is connected to a first input of the network of the crossbar switch 100a; a second beamformer DBF2 is connected to a second input of the network of the crossbar switch 100a; a third beamformer DBF3 is connected to a third input of the network of the crossbar switch 100a.

In a first example of the process illustrated in FIG. 6:
a first beam Rx-1 formed by a first beamforming algorithm, Algorithm No. 1 must be routed to a second output of the crossbar switch 100a located on the second column;
a second beam Rx-2 formed by a second beamforming algorithm, Algorithm No. 2 must be routed to the third output located on the third column of the crossbar switch 100a;
a third beam Rx-3 formed by a third beamforming algorithm, Algorithm No. 3, must be routed to a first output of the crossbar switch 100a located on the first column of the crossbar switch 100a.

In particular, initially and arbitrarily:
the first algorithm is assigned to the first beamformer DBF1;
the second algorithm is assigned to the second beamformer DBF2; and
the third algorithm is assigned to the third beamformer DBF3.

In a first step, the process determines a set of (row, column) pairs which correspond to the routing requirement defined between the upstream signals and the downstream signals of the interconnection device. In this step, all the row-column intersections of the array 100 are considered. In other words, all network intersections are taken into account to identify the need for beam routing, including network intersections that do not have an elementary switch.

In the example shown in FIG. 6:
the pair (1,2) designates a routing requirement of the first beam Rx-1 to the second output of the crossbar switch 100a;
the pair (2,3) designates a need for routing the second beam Rx-2 to the third output of the crossbar switch 100a;
the pair (3,1) designates a routing requirement for the third beam Rx-3 to the first output of the crossbar switch 100a.

In a second step, the process determines the elementary switches to be activated, taking into account the constraints on the outputs. This step first involves organising the (row, column) pairs into groups having the same rank along the first dimension X of the array, that is, along the dimension of the array along which the inputs are positioned. In particular, in the figures, the first dimension X is the dimension along which the input lines are positioned. The following line ranked groups have been identified:
group 1 corresponding to row 1: {(1,2)};
group 2 corresponding to row 2: {(2,3)};
group 3 corresponding to row rank 3: {(3,1)}.

Then, within each group, the process is used to determine an extremum column rank. The extremum rank is in particular an extreme rank, i.e. a minimum or maximum rank depending on the architecture 100a, 100b, 100c, 100d of the array.

In particular, for the crossbar switch according to the first architecture 100a, the extremum rank corresponds to the minimum rank. So, referring to FIG. 6, the minimum column rank for group 1 is column rank 2; the minimum column rank for group 2 is column rank 3; the minimum column rank for group 3 is column rank 1.

Then the groups of row ranks 1, 2, 3 are ordered according to their extremum column rank along the second dimension Y. In particular, for the crossbar switch according to the first architecture 100a, groups 1, 2, 3 are ordered in ascending order of minimum rank. In particular, with reference to FIG. 6, the groups of row ranks 1, 2, 3 are ordered as follows: {group 3, group 1, group 2}, i.e. {{(3, 1)}, {(1, 2)}, {(2, 3)}}.

Then, for each group of row ranks 3, 1, 2, the method makes it possible to successively allocate a rank (allocated rank) along the first dimension X, starting with the rank along the first dimension X forming one side of the triangular matrix. In FIG. 6, the rank following the first dimension X forming one side of the triangular matrix is the row rank 1 located on the upper side of the triangular matrix.

Thus, in general, for permutations upstream of the crossbar switch, and for the triangular-matrix type arrangement 100a, the ranking of the groups by their rank along the first dimension X (row) is carried out in decreasing order of the extremum rank of the second dimension Y; the extremum rank of the second dimension Y (column) is minimal, and the allocation of ranks along the first dimension X (row) increases.

In accordance with the same principles, the person skilled in the art will be able to adapt the classifications for the other types of assembly as follows:

For a triangular-matrix type arrangement 100b, the ranking of the groups by their rank along the first dimension X (row) is carried out in decreasing order of the extremum rank of the second dimension Y; the extremum rank of the second dimension Y (column) is maximal, and the allocation of ranks along the first dimension X (row) then increases.

For a triangular-matrix type arrangement 100c, the ranking of the groups by their rank along the first dimension X (row) is carried out in increasing order of the extremum rank of the second dimension Y; the extremum rank of the second dimension Y (column) is minimal, and the allocation of ranks along the first dimension X (row) then decreases.

For a triangular-matrix type arrangement 100d, the ranking of the groups by their rank along the first dimension X (row) is carried out in decreasing order of the extremum rank of the second dimension Y; the extremum rank of the second dimension Y (column) is maximal, and the allocation of ranks along the first dimension X (row) then decreases.

In one embodiment, in the case of a triangular matrix 100a, a counter i of rank along the first dimension X is initialised at 1, then incremented progressively at each group allocation of rank 3, 1, 2. In particular, a first table stores the correspondences between the indices of the beamforming algorithms and the indices of the beamformers DBF. A second table stores the activation of the elementary switches for all the connections to be established. Both tables are initialised empty at the start of the calculation of any new configuration of the interconnection device.

In FIG. 6, for i=1, the first line of the switch is allocated to the rank 3 group, which is intended to route the third beam RX-3. At the same time, the first table stores a correspondence between the third beamforming algorithm and the beamformer connected to the first row, namely the first beamformer DBF1. The second switch-activation table is updated for rank group 3 by substituting i=1 for row rank 3: {(3,1)} becomes {(1,1)} and is recorded in the second table.

For i=2, the second row of the switch is allocated to the rank 1 group, which is intended to route the first bundle RX-1. At the same time, the first table stores a correspondence between the first beamforming algorithm and the beamformer connected to the second row, namely the second beamformer DBF2. The second switch-activation table is updated for rank group 1 by substituting i=2 for row rank 1: {(1,2)} becomes {(2,2)} and is recorded in the second table.

For i=3, the third line of the switch is allocated to the rank 2 group, which is intended to route the second beam RX-2. At the same time, the first table stores a correspondence between the second beamforming algorithm and the beamformer connected to the third line, namely the third beamformer DBF3. The second switch-activation table is updated for rank group 2 by substituting i=3 for row rank 2: {(2,3)} becomes {(3,3)} and is recorded in the second table.

In a third step, the method allows the signals representing the beams Rx-1, Rx-2 and Rx-3 to be permuted in accordance with the previous rank allocation. In particular, the correspondences between the beamforming algorithms and the beamformers stored in the first table are used to permute the beamforming algorithms assigned to the beamformers.

Thus, in FIG. 6, the first beamforming algorithm, Algorithm No. 1 is assigned to the second beamformer DBF2; the second beamforming algorithm, Algorithm No. 2 is assigned to the third beamformer DBF3; the third beamforming algorithm, Algorithm No. 3 is assigned to the first beamformer DBF1.

In FIG. 6, following the previous steps, the elementary switches located at the intersections corresponding to the (row, column) pairs (1,1), (2,2), (3,3) have been identified in the second activation table to implement the desired routing of the beams Rx-1, Rx-2, Rx-3 through the crossbar switch.

The elementary switches corresponding to the pairs (allocated rank, column) can then be activated, that is, placed in a passing state, in order to route the beams Rx-1, Rx-2 and Rx-3 respectively to the second output, the third output and the first output.

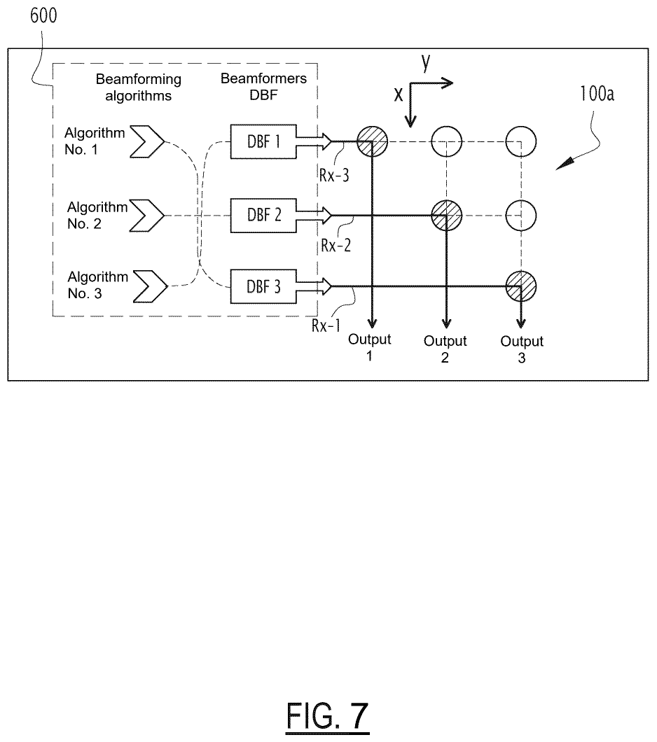

FIG. 7 shows a second example of a process for configuring a processor according to the first variant of the first embodiment with the first architecture 100a. The second example of the process is identical to the first example shown in FIG. 6, except for the routing of the beams to be obtained.

In the second example shown in FIG. 7:
the first beam Rx-1 formed by the first formation Algorithm No. 1 must be routed to the third output of the crossbar switch 100a located on the third column;
the second beam Rx-2 formed by the second formation Algorithm No. 2 must be routed to the second output located on the second column of the crossbar switch 100a;
the third beam Rx-3 formed by the third formation Algorithm No. 3 must be routed to the first output of the crossbar switch 100a located on the first column of the crossbar switch 100a.

At the end of the first step, the set of (row, column) pairs corresponding to routing requirements between the upstream and downstream signals of the switch, considering all the row-column intersections of the array, is determined as follows:
the pair (1,3) designates a routing requirement of the first beam Rx-1 to the third output of the crossbar switch 100a;
the pair (2,2) designates a need for routing the second beam Rx-2 to the second output of the crossbar switch 100a;
the pair (3,1) designates a routing requirement for the third beam Rx-3 to the first output of the crossbar switch 100a.

In the second step, the method enables the (row, column) pairs having the same rank along the first dimension X of the array to be organised into X-rank groups, or row-rank groups, and, for the example in FIG. 7, as follows:
group 1 corresponding to row rank 1: {(1,3)};
group 2 corresponding to row rank 2: {(2,2)};
group 3 corresponding to row rank 3: {(3,1)}.

Then, in each group, the method allows the minimum rank along the second dimension Y to be identified, and for the example as follows: the minimum rank for group 1 is the column rank 3; the minimum rank for group 2 is the column rank 2; the minimum rank for group 3 is the column rank 1.

Then in the next step, the groups of rank 1, 2, 3 are ordered in ascending order of the minimum column rank, and for the example in FIG. 7 as follows: {group 3, group 2, group 1}, i.e. {{(3, 1)}, {(2, 2)}, {(1, 3)}}.

Then, for each group of row ranks 3, 2, 1, the method successively allocates a rank along the first dimension X, starting with the rank along the first dimension X forming one side of the triangular matrix.

In particular, in FIG. 7, for i=1, the first line of the switch is allocated to group 3, which is intended to route the third beam RX-3. At the same time, the first table stores a correspondence between the third beamforming algorithm and the beamformer connected to the first row, namely the first beamformer DBF1. The second switch-activation table is updated for rank group 3 by substituting i=1 for row rank 3: {(3,1)} becomes {(1,1)} and is recorded in the second table.

For i=2, the second line of the switch is allocated to group 2, which is intended to route the second beam RX-2. In parallel, the first table stores a correspondence between the second beam-forming algorithm and the beamformer connected to the second row, namely the second beamformer DBF2. The second switch-activation table is updated for rank group 2 by substituting i=2 for row rank 2: {(2,2)} becomes {(2,2)} and is recorded in the second table.

For i=3, the third row of the switch is allocated to group 1, which is intended to route the first beam RX-1. At the same time, the first table stores a correspondence between the first beamforming algorithm and the beamformer connected to the third row, namely the third beamformer DBF3. The second switch-activation table is updated for rank group 3 by substituting i=3 for row rank 1: {(1,3)} becomes {(3,3)} and is recorded in the second table.

In the third step, the beams Rx-1, Rx-2 and Rx-3 are permuted in accordance with the previous rank allocation. Thus, in FIG. 7, the first beamforming algorithm is assigned to the third beamformer DBF3; the second beamforming algorithm remains assigned to the second beamformer DBF2; the third beamforming algorithm is assigned to the first beamformer DBF1.

Following the previous steps, the elementary switches located at the intersections corresponding to the (row, column) pairs (1,1), (2,2), (3,3) were identified in the second activation table to implement the desired routing of the beams Rx-1, Rx-2, Rx-3 through the crossbar switch.

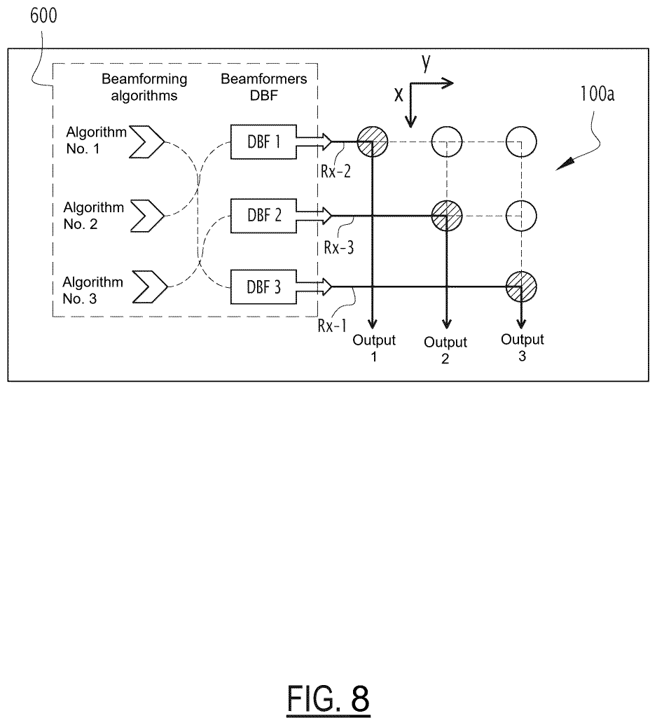

FIG. 8 illustrates a third example of a process for configuring a processor according to the first variant of the first embodiment with the first architecture 100a. The third example of the process is identical to the first example shown in FIG. 6, except for the routing of the beams to be obtained.

In the third example shown in FIG. 8:
the first beam Rx-1 formed by the first formation Algorithm No. 1 must be routed to the third output of the crossbar switch 100a located on the third column;
the second beam Rx-2 formed by the second beam-forming algorithm, Algorithm No. 2, must be routed to the first output located on the first column of the crossbar switch 100 a;
the third beam Rx-3, formed by the third beam-forming algorithm, Algorithm No. 3, must be routed to the second output of the crossbar switch 100a, located on the second column of the crossbar switch 100a.

At the end of the first step, the set of (row, column) pairs corresponding to the routing requirement between the upstream and downstream signals of the switch, considering all the row-column intersections of the array, is obtained and, for the example in FIG. 8, is as follows:
the pair (1,3) designating a need for routing the first beam Rx-1 to the third output of the crossbar switch 100a;
the pair (2,1) designating a routing requirement of the second beam Rx-2 to the first output of the crossbar switch 100a;
the pair (3,2) designating a need to route the third beam Rx-3 to the second output of the crossbar switch 100a.

In the second step, the (row, column) pairs with the same rank according to the first dimension X of the network are grouped as follows:
group 1 corresponding to row rank 1: {(1,3)};
group 2 corresponding to row rank 2: {(2,1)};
group 3 corresponding to row rank 3: {(3,2)}.

Then, in each group, the minimum rank along the second dimension Y is identified as follows: the minimum rank for group 1 is the column 3 rank; the minimum rank for group 2 is the column 1 rank; the minimum rank for group 3 is the column 2 rank.

Groups 1, 2 and 3 are then ordered in ascending order of minimum column rank, as follows: {group 2, group 3, group 1}, i.e. {(2,1)}, {(3,2)}, {(1,3)}.

Next, each of groups 2, 3 and 1 is successively allocated a rank along the first dimension X, starting with the rank along the first dimension X that forms one side of the triangular matrix.

In particular, in FIG. 8, for i=1, the first row of the switch is allocated to group 2, which is intended to route the second beam RX-2. At the same time, the first table stores a correspondence between the second beamforming algorithm and the beamformer connected to the first row, namely the first beamformer DBF1. The second switch-activation table is updated for rank group 2 by substituting i=1 for row rank 2: {(2,1)} becomes {(1,1)} and is recorded in the second table.

For i=2, the second row of the switch is allocated to group 3, which is intended to route the third beam RX-3. At the same time, the first table stores a correspondence between the third beam-forming algorithm and the beamformer connected to the second row, namely the second beamformer DBF2. The second switch-activation table is updated for rank group 3 by substituting i=2 for row rank 3: {(3,2)} becomes {(2,2)} and is recorded in the second table.

For i=3, the third row of the switch is allocated to group 1, which is intended to route the first beam RX-1. At the same time, the first table stores a correspondence between the first beamforming algorithm and the beamformer connected to the third row, namely the third beamformer DBF3. The second switch-activation table is updated for rank group 1 by substituting i=3 for row rank 1: {(1,3)} becomes {(3,3)} and is recorded in the second table.

In the third step, the beam-forming algorithms of beams Rx-1, Rx-2 and Rx-3 are permuted in accordance with the preceding rank allocation. Thus, in FIG. 8, the first beam-forming algorithm is assigned to the third beamformer DBF3; the second beamforming algorithm is assigned to the first beamformer DBF1; and the third beamforming algorithm is assigned to the second beamformer DBF2.

Following the previous steps, the elementary switches located at the intersections corresponding to the pairs of rows (1,1), (2,2), (3,3) were identified in the second activation table to implement the desired routing of the beams Rx-1, Rx-2, Rx-3 through the crossbar switch.

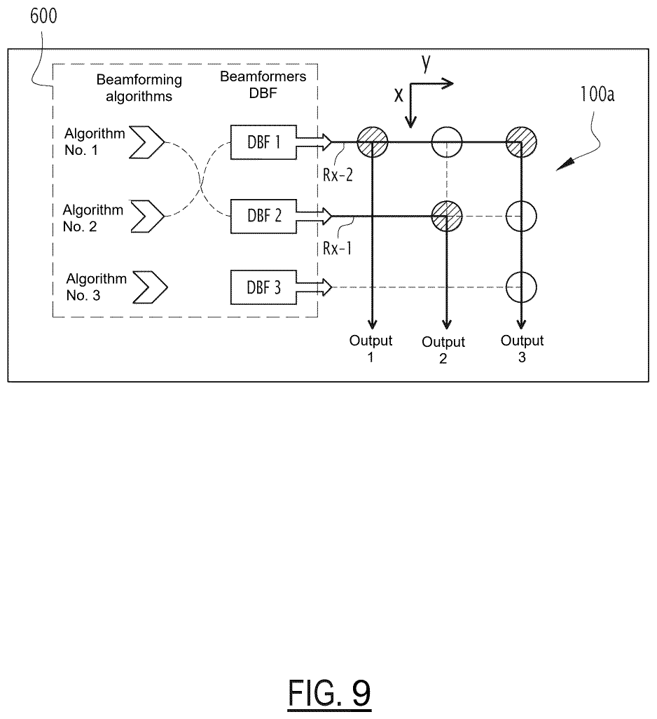

FIG. 9 shows a fourth example of a process for configuring a processor according to the first variant of the first embodiment with the first architecture 100a. The fourth example of the process is identical to the first example shown in FIG. 6, except for the routing of the beams to be obtained.

In the fourth example shown in FIG. 9:
the first beam Rx-1, formed by the first beam-forming algorithm, Algorithm No. 1, must be routed to the second output of the crossbar switch 100a, located on the second column of the crossbar switch 100a;
the second beam Rx-2, formed by the second beam-forming algorithm, Algorithm No. 2, must be routed to the first output located on the first column of the crossbar switch 100 a and to the third output of the crossbar switch 100a located on the third column;

At the end of the first step, the set of (row, column) pairs corresponding to routing requirements between the upstream and downstream signals of the switch, considering all the row-column intersections of the array, is as follows:
the pair (1,2) designating a routing requirement of the first beam Rx-1 to the second output of the crossbar switch 100a;
the pair (2,1) designating a routing requirement of the second beam Rx-2 to the first output of the crossbar switch 100a;
the pair (2,3) designating a routing requirement for the second beam Rx-2 to the third output of the crossbar switch 100a.

In the second step, row and column pairs with the same rank along the first dimension X of the array are grouped as follows:
group 1 corresponding to row rank 1: {(1,2)};
group 2 corresponding to row rank 2: {(2,1), (2,3)}.

Then, in each group, the minimum rank along the second dimension Y is identified as follows: the minimum rank for group 1 is column rank 2; the minimum rank for group 2 is column rank 1.

Then groups 1, 2 are ordered in ascending order of minimum rank, as follows: {group 2, group 1}, i.e. {{(2,1), (2,3)}, {1,2)}}.

Then, each group 1, 2 is allocated a rank successively along the first dimension X, starting with the rank along the first dimension X forming one side of the triangular matrix.

In particular, in FIG. 9, for i=1, the first line is allocated to group 2, which is intended to route the second beam RX-2. At the same time, the first table stores a correspondence between the second beamforming algorithm and the beamformer connected to the first row, namely the first beamformer DBF1. The second switch activation table is updated for the rank 2 group by substituting i=1 for row rank 2: {(2,1), (2,3)} becoming {(1,1), (1,3)} is stored in the second table.

For i=2, the second row is allocated to group 1, which is intended to route the first beam RX-1. At the same time, the first table stores a correspondence between the first beamforming algorithm and the beamformer connected to the second row, namely the second beamformer DBF2. The second switch-activation table is updated for rank group 1 by substituting i=2 for row rank 1: {(1,2)} becomes {(2,2)} and is recorded in the second table.

In the third step, beams Rx-1, Rx-2 are permuted in correspondence with the previous rank allocation. Thus, in FIG. 9, the first beamforming algorithm is assigned to the second beamformer DBF2; and the second beamforming algorithm is assigned to the first beamformer DBF1.

Following the previous steps, the elementary switches located at the intersections corresponding to the (row, column) pairs (1,1), (1,3), (2,2) were identified in the second activation table to implement the desired routing of beams Rx-1, Rx-2 through the crossbar switch.

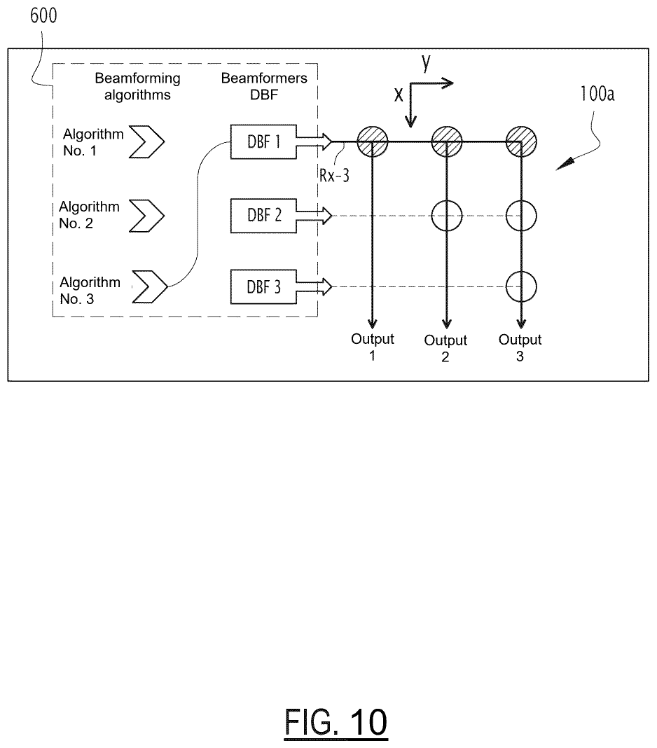

FIG. 10 shows a fifth example of a process for configuring a processor according to the first variant of the first embodiment with the first architecture 100a. The fifth example of the process is identical to the first example shown in FIG. 6, except for the routing of the beams to be obtained. So, in the fifth example shown in FIG. 10, the third beam Rx-3 formed by the third algorithm is to be routed to the first, second and third outputs of the crossbar switch 100a.

At the end of the first step, the set of (row, column) pairs corresponding to routing requirements between the upstream and downstream signals of the switch, considering all the row-column intersections of the array, is as follows:
the pair (3,1) designating a need to route the third beam Rx-3 to the first output of the crossbar switch 100a;
the pair (3,2) designating a need to route the third bundle Rx-3 to the second output of the crossbar switch 100a;
the pair (3,3) designating a need to route the third beam Rx-3 to the third output of the crossbar switch 100a.

In the second step, the (row, column) pairs with the same rank along the first dimension X of the array are grouped as follows: group 3 corresponding to row rank 3: {(3,1), (3,2), (3,3)}.

Then, for i=1, the first row is allocated to group 3, which is intended to route the third beam RX-3. At the same time, the first table stores a correspondence between the third beamforming algorithm and the beamformer connected to the first row, namely the first beamformer DBF1. The second switch-activation table is updated for rank group 3 by substituting i=1 for row rank 3: {(3,1), (3,2), (3,3)} becomes {(1,1), (1,2), (1,3)} and is recorded in the second table. In the third step, shown in FIG. 10, the third beamforming algorithm is assigned to the first beamformer DBF1.

Following the previous steps, the elementary switches located at the intersections corresponding to the (row, column) pairs (1,1), (1,2), (1,3) were identified in the second activation table to implement the desired routing of the beam Rx-3 through the crossbar switch.

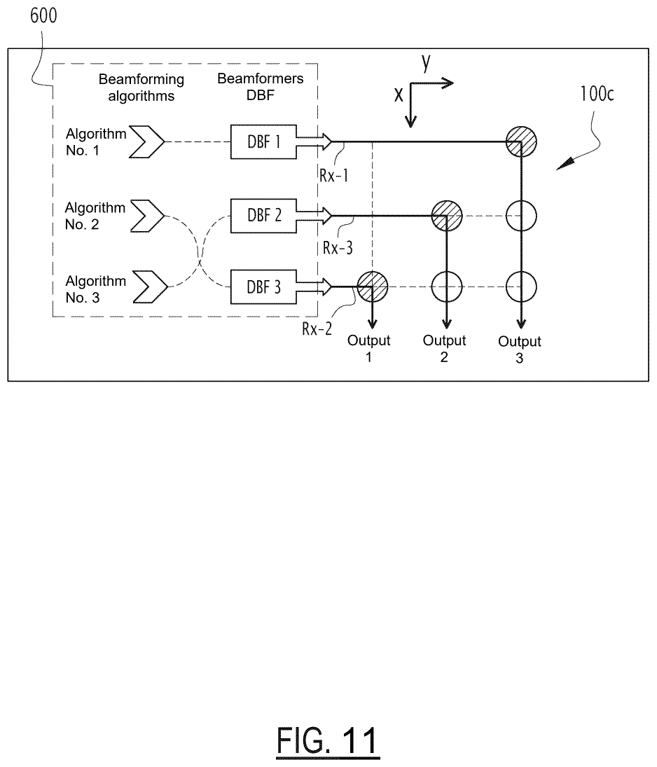

As illustrated in FIGS. 6 to 10, the reconfiguration process according to the disclosure therefore makes it possible to obtain a unicast or multicast connection in a processor according to the first variant of the first embodiment with the first architecture 100a. The other architectures 100b, 100c and 100d can also be used to obtain unicast or multicast connections, as explained below in relation to FIGS. 11 to 16.

In particular, in the first variant of the first embodiment, the permutation of beamforming algorithms is a function of the initial distribution of beamforming algorithms between beamformers DBF1, DBF2, DBF3.

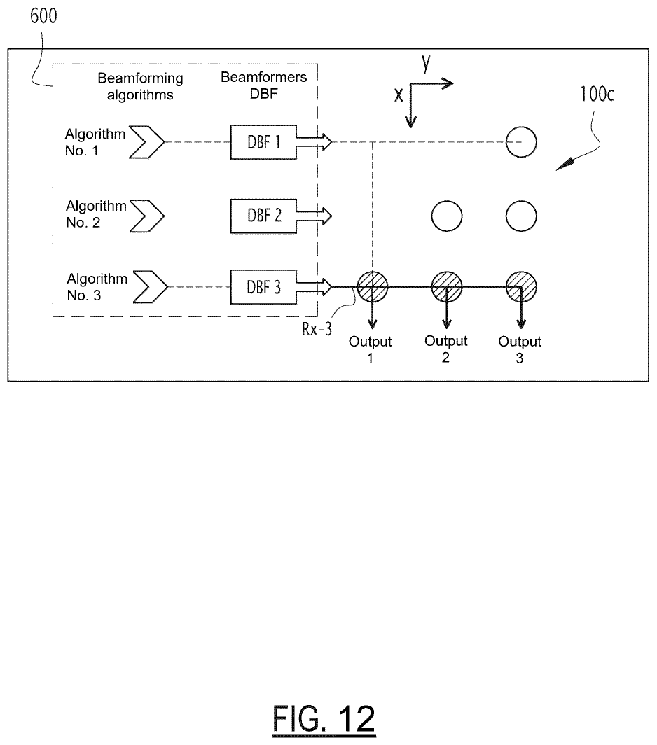

FIGS. 11 and 12 show examples of a process for configuring a processor according to the first variant of the first embodiment with the third architecture 100c. In the first variant of the first embodiment with the third architecture 100c, the configuration method is identical to that for the first variant of the first embodiment with the first architecture 100a, except that the order of row allocation per group is performed in decreasing order starting from the last row forming a side of the triangular matrix.

In particular, in a sixth example of the method illustrated in FIG. 11, according to this first variant of the first embodiment with the third architecture 100c, the routing to be achieved is identical to that of the third example illustrated in FIG. 8, as is the initial distribution of the beamforming algorithms among the beamformers. However, the elementary switches to be activated are not the same because the 100a and 100c architectures are different. In FIG. 11, the elementary switches located at the intersections corresponding to the (row, column) pairs (1,3), (2,2), (3,1) are identified to implement the desired routing of the beams Rx-1, Rx-2, Rx-3 through the crossbar switch. The first beamforming algorithm remains assigned to the first beamformer DBF1; the second beamforming algorithm is assigned to the third beamformer DBF3; the third beamforming algorithm is assigned to the second beamformer DBF2.

In a seventh example of the process shown in FIG. 12, according to this first variant of the first embodiment with the third architecture 100c, the routing to be obtained is identical to that of the fifth example shown in FIG. 10, as is the initial distribution of the beamforming algorithms in the beamformers. However, the elementary switches to be activated are not the same because the 100a and 100c architectures are different. In FIG. 12, the elementary switches located at the intersections corresponding to the (row, column) pairs (3,1), (3,2), (3,3) are identified to implement the desired routing of the beam Rx-3 through the crossbar switch. The third beamforming algorithm remains assigned to the third beamformer DBF3.

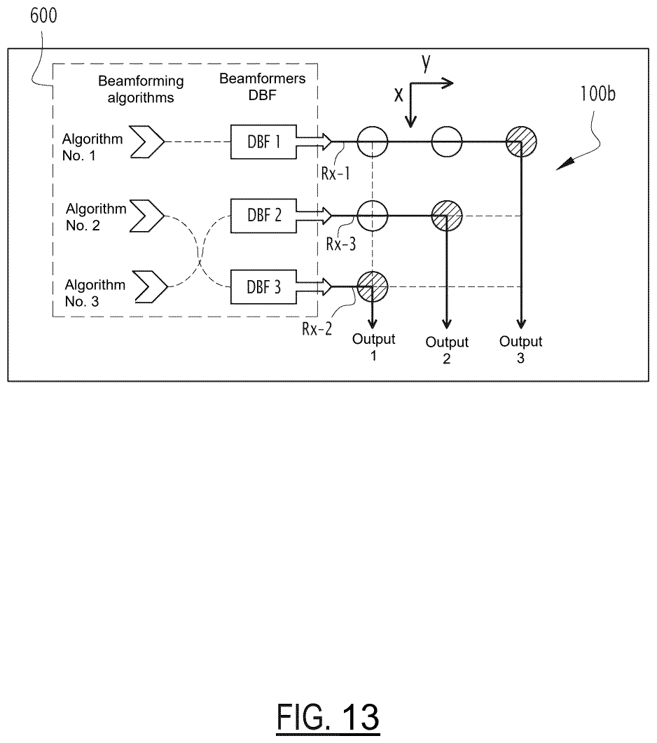

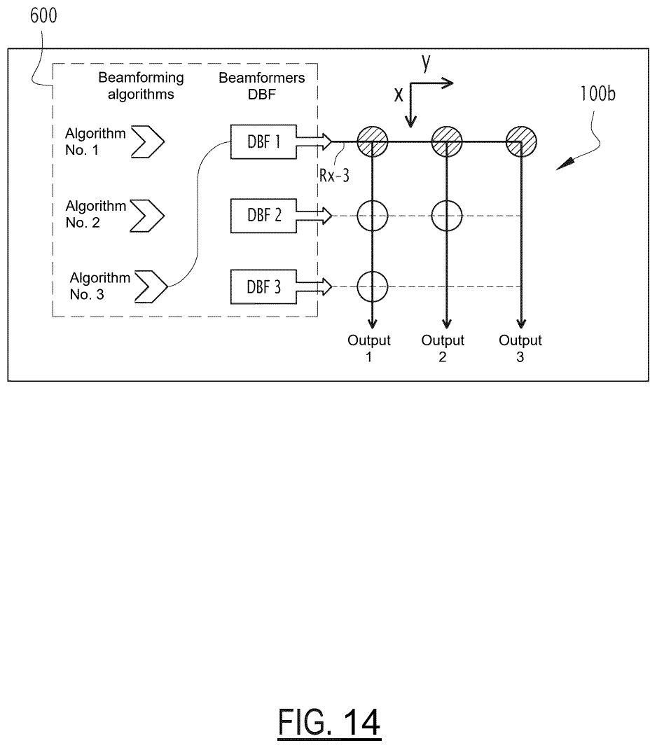

FIGS. 13 and 14 show examples of a process for configuring a processor according to the first variant of the first embodiment with the second architecture 100b. In the first variant of the first embodiment with the second architecture 100b, the configuration method is identical to that of the first variant of the first embodiment with the first architecture 100a, except that the determination of an extremum rank along the second dimension Y in each group of pairs corresponds, in each group, to determining the maximum rank along the second dimension Y; and the ordering of the groups of pairs is carried out in decreasing order of the maximum rank along the second dimension Y.

In particular, in an eighth example of the process shown in FIG. 13, according to this first variant of the first embodiment with the second architecture 100b, the routing to be obtained is identical to that in the third example shown in FIG. 8, as is the initial distribution of the beamforming algorithms in the beamformers. In addition, the steps of determining the (row, column) pairs corresponding to paths between the inputs and outputs, and organising the (row, column) pairs into rank groups having the same rank along the first dimension X are identical.

In the eighth example method, the steps of determining an extremum rank along the second dimension Y and ordering the groups of pairs are different as follows. In each group, the maximum rank along the second dimension Y is identified as follows: the maximum rank for group 1 is the column rank 3; the maximum rank for group 2 is the column rank 1; the maximum rank for group 3 is the column rank 2. Groups 1, 2 and 3 are then ordered in descending order of maximum rank, as follows: {group 1, group 3, group 2} , i.e. {(1,3)}, {(3,2)}, {(2,1)}.

Next, the step of successively allocating a rank along the first dimension X to each group remains identical to that of the third example shown in FIG. 8. Each group 1, 3, 2 is successively allocated a rank along the first dimension X, starting with the rank along the first dimension X forming one side of the triangular matrix.

In particular, in FIG. 13, for i=1, the first line is allocated to group 1, which is intended to route the first beam RX-1. At the same time, the first table stores a correspondence between the first beamforming algorithm and the beamformer connected to the first row, namely the first beamformer DBF1. The second switch activation table is updated for group rank 1 by substituting i=1 for row rank 1: {(1,3}} remaining {(1,3)} is stored in the second table.

For i=2, the second row is allocated to group 3, which is intended to route the third beam RX-3. At the same time, the first table stores a correspondence between the third beam-forming algorithm and the beamformer connected to the second row, namely the second beamformer DBF2. The second switch-activation table is updated for rank group 3 by substituting i=2 for row rank 3: {(3,2)} becomes {(2,2)} and is recorded in the second table.

For i=3, the third line is allocated to group 2, which is intended to route the second beam RX-2. At the same time, the first table stores a correspondence between the second beamforming algorithm and the beamformer connected to the third line, namely the third beamformer DBF3. The second switch activation table is updated for the row 2 group by substituting i=3 for row rank 2: {(2,1)} becomes {(3,1)} and is stored in the second table.

In the third step, the beams Rx-1, Rx-2 and Rx-3 are permuted in accordance with the previous rank allocation. Thus, in FIG. 13, the first beamforming algorithm remains in the first beamformer DBF1; the second beamforming algorithm is assigned to the third beamformer DBF3; the third beamforming algorithm is assigned to the second beamformer DBF2.

Following the previous steps, the elementary switches located at the intersections corresponding to the (row, column) pairs (1,3), (2,2), (3,1) were identified in the second activation table to implement the desired routing of beams Rx-1, Rx-2, Rx-3 through the crossbar switch.

A ninth example of a process according to the first variant of the first embodiment with the second architecture 100b is shown in FIG. 14. The ninth example of the process is identical to the eighth example of the process, except for the routing of the beams to be obtained, which is identical to that of the fifth example shown in FIG. 10. By applying the same steps as in the eighth example of the process, the elementary switches located at the intersections corresponding to the (row, column) pairs (1,1), (1,2), (1,3) are identified to implement the desired routing of the beams Rx-1, Rx-2, Rx-3 through the crossbar switch. The third beamforming algorithm is assigned to the first beamformer DBF1.

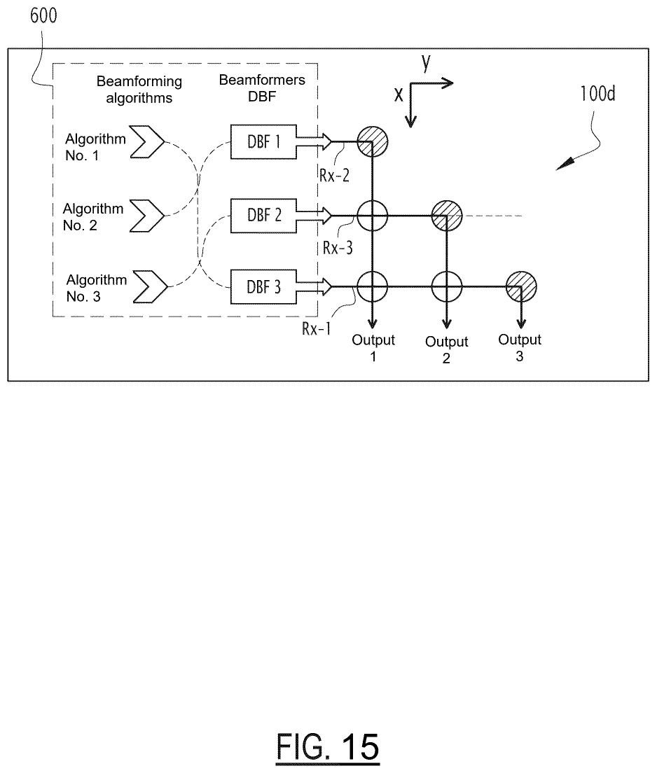

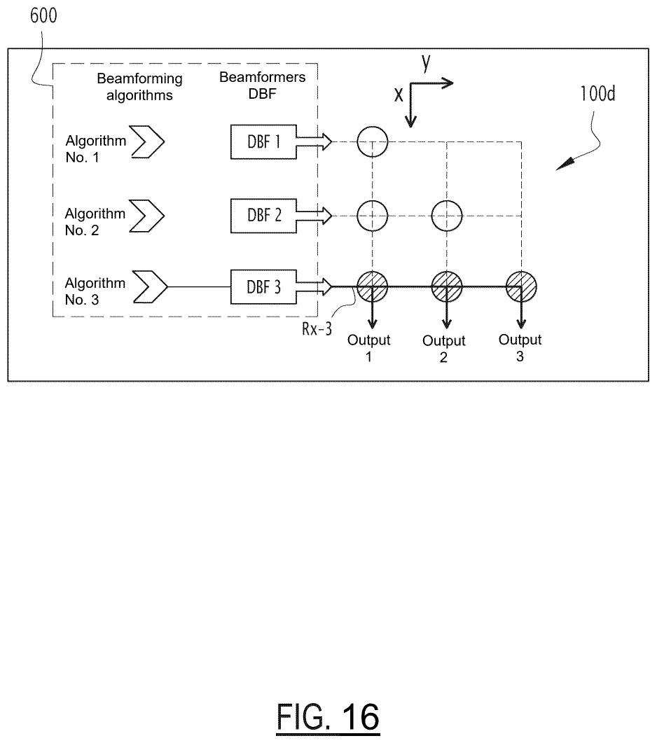

FIGS. 15 and 16 show examples of a process for configuring a processor according to the first variant of the first embodiment with the fourth architecture 100d. In the first variant of the first embodiment with the fourth architecture 100d, the configuration method is identical to that for the first variant of the first embodiment with the second architecture 100b, except that the order of allocation of the rows per group is performed in descending order starting from the last row forming a side of the triangular matrix.

In particular, in a tenth example of the process shown in FIG. 15, according to this first variant of the first embodiment with the fourth architecture 100d, the routing to be obtained is identical to that in the third example shown in FIG. 8, as is the initial distribution of the beamforming algorithms in the beamformers. In this particular case, the elementary switches to be activated are the same. In FIG. 15, the elementary switches located at the intersections corresponding to the (row, column) pairs (1,1), (2,2), (3,3) are identified to implement the desired routing of the beams Rx-1, Rx-2, Rx-3 through the crossbar switch. In addition, the first beamforming algorithm is assigned to the third beamformer DBF3; the second beamforming algorithm is assigned to the first beamformer DBF1; the third beamforming algorithm is assigned to the second beamformer DBF2.

In an eleventh example of the process shown in FIG. 16, according to this first variant of the first embodiment with the fourth architecture 100d, the routing to be obtained is identical to that of the fifth example shown in FIG. 10. However, the elementary switches to be activated are not the same because the 100a and 100d architectures are different. Thus, in FIG. 16, the elementary switches located at the row-column intersections corresponding to the (row, column) pairs (3,1), (3,2), (3,3) are identified to implement the desired routing of the beam Rx-3 through the crossbar switch. The third beamforming algorithm remains assigned to the third beamformer DBF3.

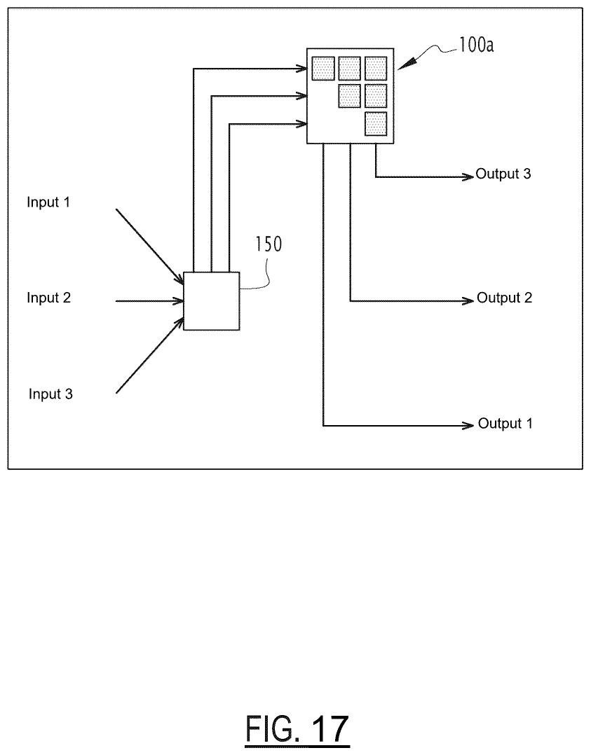

In a second variant of the first embodiment, illustrated in FIG. 17, the permutation device comprises a switch 150 connected upstream of the crossbar switch 100a. The switch 150 is configured to optionally permute the signals originating from the receive antenna or antennas upstream of the inputs of the crossbar switch, depending on the configuration of the connections between the inputs and outputs of the crossbar switch.

In particular, the switch 150 comprises inputs for receiving signals from the receive antenna(s), and outputs which are connected to the inputs of the crossbar switch 100a (or 100b or 100c or 100d). The switch 150 performs a permutation of the signals upstream of the crossbar switch inputs in correspondence with the rank allocation step.

The switch 150 can be made using microelectromechanical systems (MEMS) technology.

The switch 150 may, for example, be an optical unicast switch forming a square array of the same dimension as the crossbar switch (100a, 100b, 100c or 100d). The optical switch 150 can then comprise an array of mirrors which, in particular, allows negligible power dissipation. In particular, fast serial fibre optic communication links can be used to propagate digital signals with high throughput and good power efficiency. Such links make it possible to overcome limitations in the lengths of the paths between the electronic units of the telecommunications processor, such as electronic cards or other equipment that may, for example, be on board a satellite.

The second variant of the first embodiment is advantageous when the telecommunication processor, which comprises the reconfigurable interconnection device, has no beamformers for performing permutations upstream or downstream of the reconfigurable interconnection device.

The procedure for configuring the reconfigurable interconnection device according to the second variant of the first embodiment is identical to that according to the first variant of the first embodiment, except that the signals are no longer permuted by permuting the beamforming algorithms. In the second variant, the signals at the inputs of the crossbar switch (100a or 100b or 100c or 100d) are switched by changing the connection between the inputs and outputs of the switch 150. In particular, the configuration process varies with the 100a, 100b, 100c, 100d architecture as described above. The configuration method makes it possible to obtain a unicast or multicast connection in the device according to the second variant of the first embodiment, in particular with one of the architectures 100a, 100b, 100c or 100d, illustrated in FIG. 5.

In the first and second variants of the first embodiment, the elementary switches are preferably 1×1 or 2×1 switches.

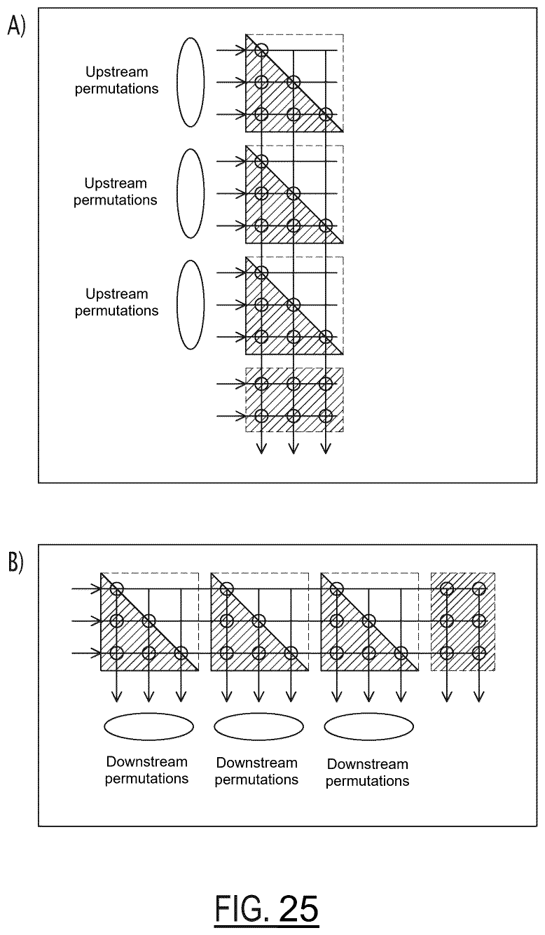

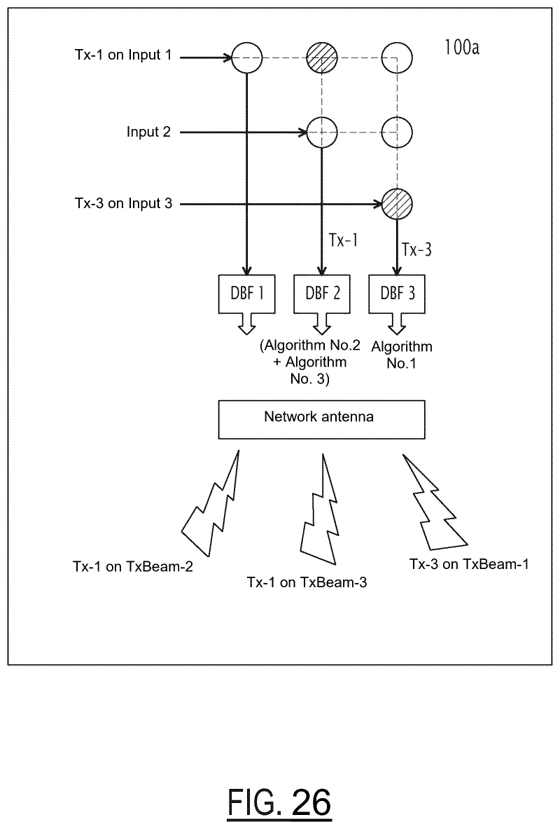

In a third variant of the first embodiment illustrated in FIGS. 25b and 26, the permutation device comprises digital beamformers (DBFs) on transmit. The transmit beamformers DBF are located downstream of the reconfigurable interconnection device, and therefore of the crossbar switch 100a, 100b, 100c, 100d. In a manner known per se, each beamformer DBF1, DBF2, DBF3 receives as input one of the signals Tx-1, Tx-2, Tx-3 and produces as output excitation signals for elementary antennas of the transmitting array antenna, as a function of a beamforming algorithm. The signals Tx-1, Tx-2, Tx-3 correspond to the radio frequency signals to be transmitted in the beam directions defined by the formation algorithms, Algorithm No. 1, Algorithm No. 2, Algorithm No. 3, configured in the trainers, which must then be radiated by the transmitting antennas. For example, in FIG. 26, the signal Tx-3 is routed and radiated on the TxBeam-1 corresponding to Algorithm No. 1.

In this third variant of the first embodiment, the beamforming algorithms can be permuted and combined depending on the configuration of the connections to be established between the inputs and outputs of the crossbar switch 100a, 100b, 100c, 100d. Thus, routing of signals, in particular beams, through the crossbar switch 100a, 100b, 100c, 100d can be obtained by activating the elementary switches according to a configuration adapted to the constraints of the triangular arrangement of the elementary switches, then by permuting and possibly combining the beamforming algorithms so as to modify the distribution of the signals Tx-1, Tx-2, Tx-3 between the outputs of the crossbar switch. For example, in FIG. 26, Algorithm No. 1 for forming the TxBeam1, initially and arbitrarily associated with the DBF1 formatter, is allocated by permutation to the DBF3 formatter; the output signals from the formatters, downstream of the crossbar switch, are thus permuted as a result of the permutation of the algorithms on the formatters. In this first variant, the transmit beamformers, which are also present in the telecommunications processor, are used as a permutation device. This optimises switching resources in the telecoms processor.

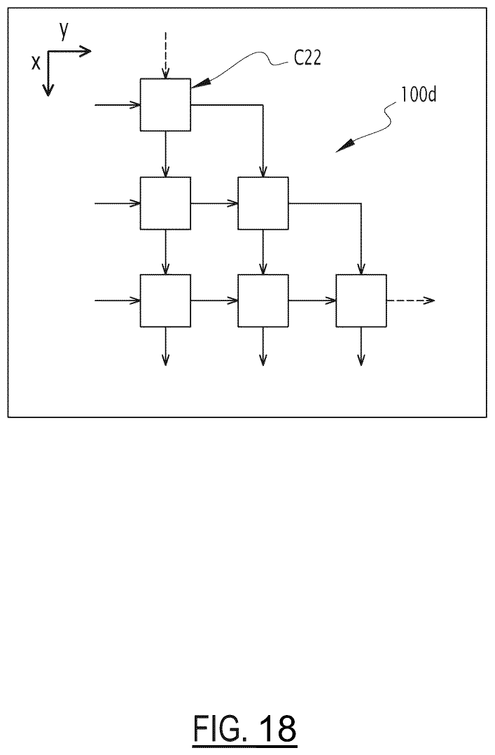

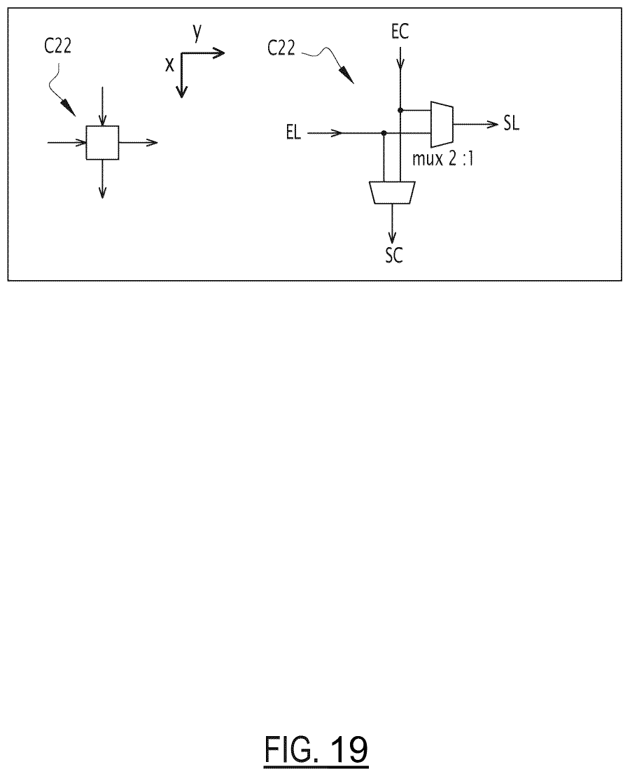

FIGS. 18 and 19 illustrate a second embodiment in which the non-blocking nature of the crossbar switch is achieved by means of an elementary switch type and a particular architectural chaining of the switch signals on the diagonal.

In this embodiment, the elementary switches are 2×2 switches. A 2×2 switch is shown in FIG. 19, as an example. The 2×2 switch referenced C22 makes two independent connections, between the two inputs and each output. It thus selectively makes a connection between, on the one hand, a first input EL along the first dimension X or a second input EC along the second dimension Y, and, on the other hand, a first output SL along the first dimension X or a second output SC along the second dimension Y.

In particular, the first input EL is on a row; the second input EC is on a column; the first output SL is on a row; and the second output SC is on a column. However, the roles of the rows and columns could be reversed, depending on the choice of the first dimension X and the second dimension Y. The choice of connection between the first input EL or the second input Ec, and the first output SL or the second output Sc, can be implemented by two multiplexing functions mux 2:1. The selection can be made using independent controls which allow any combination of inputs EC, EL and outputs SC, SL. For example, a signal on one of the inputs can be transmitted simultaneously to the first output SL and the second output SC. By being positioned at the row-column intersections of the triangular array of the crossbar switch, the 2×2 switches C22 can propagate a signal progressively from one row or column to the next.

The 2×2 switches C22 form a lower triangular matrix along the main diagonal. In other words, the 2×2 switches C22 are arranged according to the fourth architecture 100 d shown in FIG. 5. However, other arrangements 100a, 100b or 100c are also possible, with appropriate wiring.

An example of a process for configuring a processor according to the second embodiment is now described. The process seeks to achieve the following routing:
a first signal must be routed to a second output of the crossbar switch 100d located on the second column;
a second signal must be routed to the third output located on the third column of the crossbar switch 100d;
a third signal must be routed to a first output of the 100d crossbar switch located on the first output.

Initially:
the first signal is delivered to a first input of the crossbar switch 100d located on the first row;
the second signal is delivered to a second input of the crossbar switch 100d located on the second row;
the third signal is delivered to a third input of the crossbar switch 100d located on the third row.

This process example comprises a first step of determining the (row, column) pairs which correspond to routing requirements to be established between the inputs and outputs, which is identical to that described in relation to the first embodiment. In this example, the (row, column) pairs identified are as follows: (1, 2), (2, 3), (3,1).

The second stage of determining the elementary switches to be activated is different. In particular, each row and column pair corresponds to a set of 2×2 switches C22 to be activated.

If the row-column intersection corresponding to the (row, column) pair is located outside the triangular matrix, as is the case for pairs (1,2), (2,3), the following steps are carried out.

The 2×2 switches C22 located on the same row along the first dimension X as the line of the pair (row, column) are configured so that the first input EL is connected to the first output SL. In particular, for the pair (1,2), the 2×2 switch C22 located at row rank 1 is activated so that its first input EL is connected to its first output SL.

The 2×2 switches C22 located on the main diagonal between the pair's rank along the first dimension X and the pair's rank along the second dimension Y are configured so as to connect their second input EC to their first output SL. In particular, for the pair (1,2), there is no 2×2 switch C22 located on the main diagonal between row 1 and column 2. We then move on to the next step.

The 2×2 switches C22 located on the same row along the second dimension Y as the column of the pair (row, column) are configured so as to connect their second input EC with their second output SC. In particular, for the pair (1,2), the 2×2 switches C22 located at column rank 2 are activated so that their second input EC is connected to their second output SC. In this way, the signal delivered at the first input is propagated to the second output.

The 2×2 switches C22 to be activated for the pair (2,3) are determined in a similar way. The 2×2 switches C22 located on row rank 2 are activated, so that their first EL input is connected to their first SL output. For the pair (2, 3), there is no 2×2 switch C22 located on the main diagonal between row rank 2 and column rank 3. The 2×2 switches C22 located at column rank 3 are activated so that their second input EC is connected to their second output SC.

In this way, the signal delivered at the second input is propagated to the third output.

If the intersection corresponding to the pair (row, column) is located in the triangular matrix, as is the case for the pair (3, 1), the following steps are carried out.

The 2×2 switches C22 located at the same rank along the first dimension X as the row of the (row, column) pair, and having a rank along the second dimension Y that is lower than that of the row-column pair, are configured so as to connect their first input EL to their first output SL. In particular, for the pair (3,1), there is no 2×2 switch C22 located on row rank 3, and having a column rank lower than 1.

The 2×2 switch C22 located at the intersection corresponding to the row and column pair is configured so as to connect its first input EL with its second output Sc. In particular, for the pair (3,1), the 2×2 switch C22 located at the intersection of row rank 3 and column rank 1 is activated so that its first input EL is connected to its second output SC.

The 2×2 switches C22 located at the same rank along the second dimension as the column of the (row, column) pair, and having a rank along the first dimension X that is greater than that of the pair, are configured so as to connect their second input EC to their second output SC. In particular, for the pair (3,1), there is no 2×2 switch C22 located at column rank 1 with a row rank higher than 3.

In this way, the signal delivered at the third input is propagated to the first output.

The arrangement of the 2×2 switches C22 in the second embodiment ensures that the crossbar switch is non-blocking for unicast and multicast connections. The second embodiment is particularly advantageous when the telecommunications processor, which includes the reconfigurable interconnection device, has no receive beamformers upstream of the reconfigurable interconnection device.

In particular, in the examples of processors according to the disclosure, the implementation of the switches is mainly dimensioned by the interfaces providing signal transmission between the integrated circuits implementing the elementary switches. The second embodiment reduces the number of interface links within the crossbar switch, leading to a reduction in power dissipation.

In the telecommunication processor examples, the reconfigurable interconnection device may be formed by the crossbar switch 100a, 100b, 100c or 100d. Alternatively, the reconfigurable interconnect device may comprise other components.

In particular, in a third embodiment, the reconfigurable interconnection device is a known Clos network, the crossbar switch 100a, 100b, 100c, 100d forming a central stage of the Clos network. The Clos network forms a multi-stage architecture, notably comprising an odd number of stages, greater than or equal to three. By routing signals over different stages, efficiency in terms of hardware resources and dissipation is improved compared with using a single stage comprising a crossbar switch. The third embodiment is compatible with the first and second embodiments.

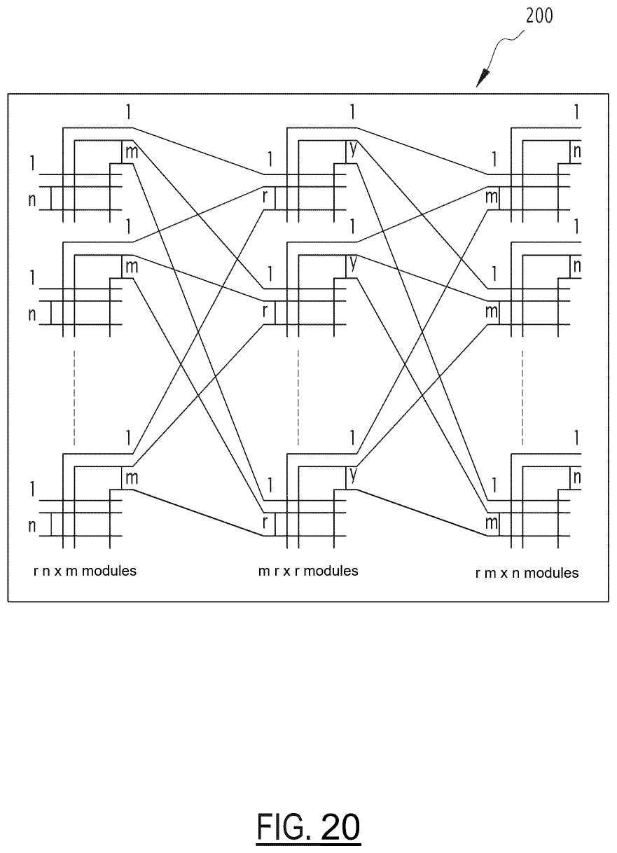

An example of a Clos network 200 in which all the stages are implemented by crossbar switch modules is shown in FIG. 20. The Clos network 200 has three stages, but could have another odd number of stages. In particular, each stage takes the form of a column of crossbar switch modules. In particular, each crossbar switch module of a stage is connected to each crossbar switch module of the upstream stage and to each module of the downstream stage.

In particular, the Clos network 200 comprises an input stage comprising r n×m crossbar switch modules. A central stage comprises m modules of crossbar switches of dimensions r×r. Each module of the central stage corresponds to the crossbar switch 100a, 100b, 100c, 100d forming a triangular matrix, described in relation to the previous embodiments. An output stage comprises r crossbar switch modules of dimensions m×n. The Clos network 200 as a whole forms a square network of dimensions (rn)×(rn).

In particular, the non-blocking nature of the Clos network 200 depends on the number m of modules in the central stage. Thus, the network is strictly non-blocking if

m≥nᵢ+n₀−1 [Math 1]

where nᵢ is the number of inputs of a crossbar switch module in the input stage, and n0 is the number of outputs of a crossbar switch module in the output stage.

The Clos network is non-blocking provided that previous connections are rearranged if

m≥max(nᵢ,n₀). [Math 2]

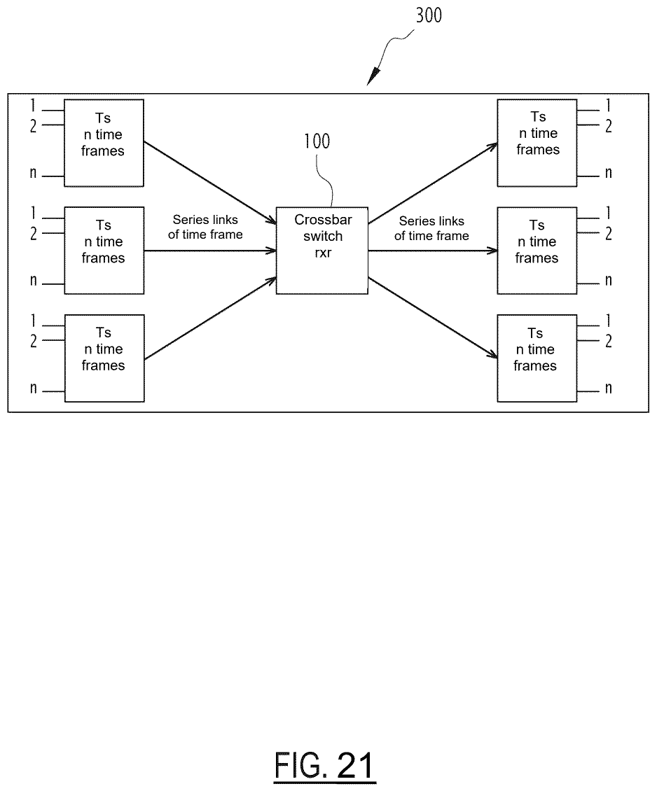

In another example of a Clos network 300 shown in FIG. 21, the input stage and the output stage can be implemented with modules using time-division multiplexing. The central stage is implemented by a single space-type module, connected to each module of the input and output stages. The routing processes in the input stage and output stage are carried out in time (T), while the routing processes in the central stage are carried out in space (S). The Clos network is then said to be of the T-S-T type (temporal-spatial-temporal). With the time-division multiplexing, the T-S-T type Clos network 300 uses a single central stage module to carry out the routing operations of the m instances of central stage modules of the space type Clos network 200. To this end, the operating frequency of the central stage module is preferably accelerated m times compared with that of the space-type Clos network 200.

In particular, the input stage comprises several time routing modules Ts, each having its output connected to an input of the crossbar switch 100a, 100b, 100c, 100d. In particular, each time module Ts comprises n inputs, a memory and an output transmitting a frame. Each slot in the frame corresponds to an input-output signal in the spatial Clos network 200. In particular, the frame comprises at least m time slots. In particular, signal routing is then performed by writing the values of the n input signals into the memory in a first order, then reading the memory back out according to a second order defining the routing configuration, to produce the output frame. In particular, the output stage operates in a dual way to the input stage.

Preferably, the signals are transmitted between the modules Ts of the input or output stage and the central stage module via fast serial links. In particular, such links are suitable for very high throughput of time frames with good energy efficiency. The links can be electrical, for example coaxial cables, or optical, for example optical fibres.

With the T-S-T type Clos network, the reconfigurable interconnection device requires fewer module instances and interface links, and is therefore simpler to implement; this is achieved in particular by accelerating the routing operations within the telecommunications processor and increasing the data rates on the interfaces.

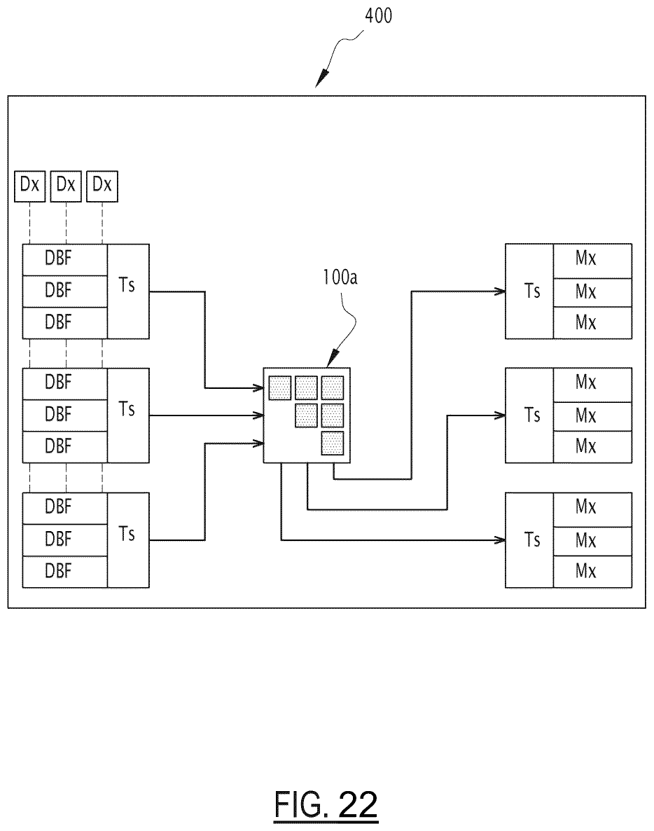

FIG. 22 illustrates an example of a telecommunications processor 400 comprising a permutation device formed by receive beamformers, as previously described in relation to the first variant of the first embodiment, and a reconfigurable interconnection device forming a T-S-T Clos network.

In particular, the beamformers DBF are associated in groups with respective time routing modules Ts of the input stage. The example processor 400 may include demultiplexers Dx configured to break down the signals from the receiving antenna(s) into their elementary frequency components. The frequency components produced by the demultiplexers Dx can then be processed by the beamformers DBF. The time modules Ts of the output stage may be grouped together and associated with multiplexers Mx that reassemble the signals to be transmitted by the transmit antenna(s).

Preferably, the beamformers DBF are located downstream of filter banks that perform a spectral decomposition of the signals from the receiving antenna(s). In particular, for digital beamformers, a spectral decomposition of the useful band, in particular into elementary bands, is carried out for all the signals from the receiving antenna(s). Each digital beamformer processes the relevant elementary strips to form a beam in a direction specific to each elementary strip. A digital beamformer can produce beams in different directions for different sub-bands by time-division multiplexing. For any signal routing requirement, it is then possible to find a permutation of the beamforming algorithms for the sub-bands and directions, particularly in association with a suitable configuration of the modules Ts of the input stage.

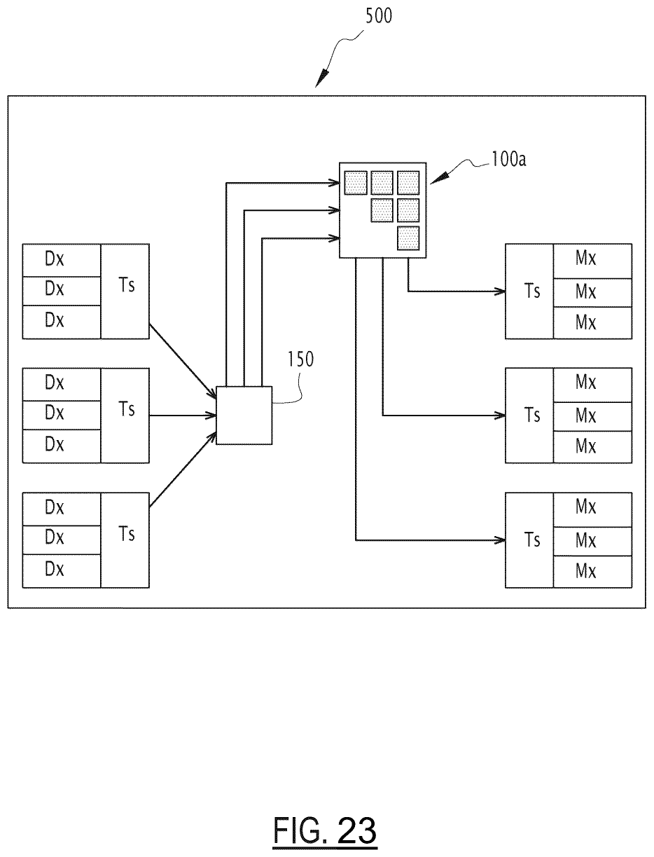

FIG. 23 illustrates an example of a telecommunications processor 500 comprising a permutation device formed by a switch 150, as previously described in relation to the second variant of the first embodiment, and a reconfigurable interconnection device 100a forming a T-S-T Clos network. In particular, the switch 150 is connected between the input stage and the central stage of the Clos network, so as to enable signal permutations upstream of the central stage inputs. The telecommunications processor 500 is notably devoid of receive beamformers DBF. The example processor 500 may include demultiplexers Dx configured to break down the signals from the receiving antenna(s) into their frequency components by elementary bands. In particular, the demultiplexers Dx are associated in groups with respective time routing modules Ts of the input stage. The time routing modules Ts of the output stage can be associated in groups with multiplexers Mx which recompose the signals intended to be transmitted by the transmitting antenna(s). In this example, which includes the switch 150 as a permutation device, permutations are performed transparently downstream of the modules Ts of the input stage. This is also the case if the Clos network is spatial.

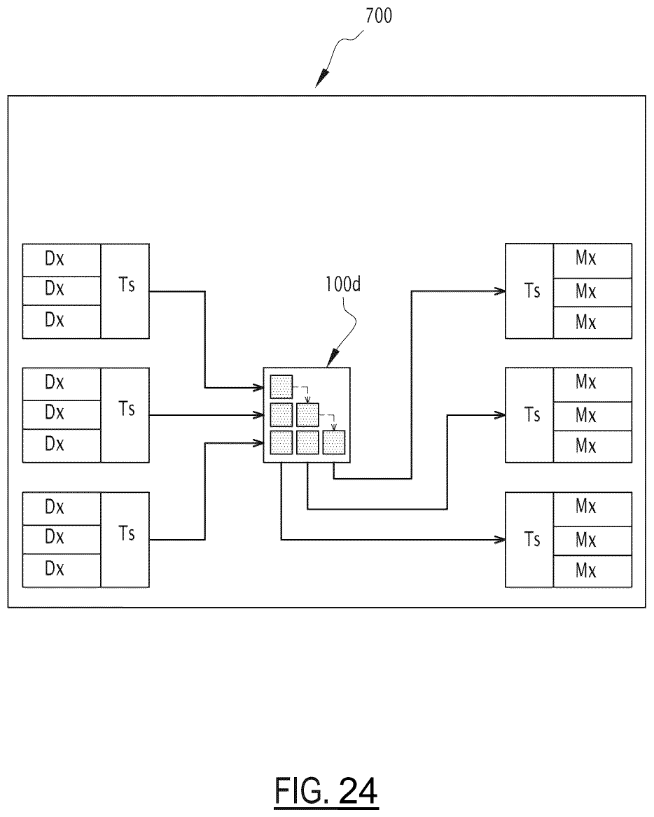

FIG. 24 illustrates an example of a telecommunications processor 700 according to the second embodiment as described above, with the reconfigurable interconnection device 100d forming a T-S-T Clos network. In particular, the telecoms processor 700 has no receive beamformers DBF. The example processor 700 may comprise demultiplexers Dx configured to decompose the signals originating from the antenna or antennas into their elementary frequency components. In particular, the demultiplexers Dx are associated in groups with respective time modules Ts of the input stage. The time modules Ts of the output stage can be associated in groups with multiplexers Mx which format the signals to be transmitted by the transmitting antenna(s).

In the case of a rectangular matrix network with a number of rows N greater than the number of columns P, N>P, the matrix network is arranged in the form of a set of square matrix sub-networks using triangular assemblies of elementary switches, possibly supplemented by a full or partial rectangular matrix network. Permutations can then be made upstream or downstream of the matrix network.

FIG. 25a illustrates a general case of permutations upstream of the matrix network according to the disclosure, in the case N>P.

The optional rectangular matrix subnet enables unicast and multicast connections to be made on input signals without upstream and downstream permutations. Its configuration is that of a full crossbar switch.

In the case of a rectangular matrix network with a number of rows N smaller than the number of columns P, N<P, the matrix network is arranged in the form of a set of square matrix sub-networks using triangular assemblies of elementary switches, possibly supplemented by a full or partial rectangular matrix network. Permutations can then be performed downstream of the matrix network.

FIG. 25b illustrates a general case of downstream permutations of the matrix network according to the disclosure.

In the case of a telecommunications processor with transmit beamforming, permutations can be performed downstream of the triangular array. With transmit beamformers, it is then sufficient to permute and/or combine the beam-forming algorithms. Downstream permutations with transmit beamformers enable all the connections (i, j) to be made with the partial network of elementary switches.

In general, for permutations downstream of the crossbar switch, and for the triangular-array type arrangement 100a, the ranking of the groups by their rank along the first dimension X (row) is carried out in decreasing order of the rank along the first dimension X; and the allocation of ranks along the second dimension Y (column) is decreasing.

Using the same principles, the person skilled in the art will be able to adapt the classifications for other types of assembly.

Thus, for a type of assembly according to a triangular matrix 100b, the classification of the groups of rank of first dimension X (row) is carried out in descending order of the rank of first dimension X; and the allocation of rank of second dimension Y (column) is then increasing.

For a type of assembly according to a triangular matrix 100c, the classification of the groups of rank of the first dimension X (row) is carried out in ascending order of the rank of the first dimension X; and the allocation of rank of the second dimension Y (column) is then descending.

For a type of assembly according to a triangular matrix 100d, the classification of the groups of rank of the first dimension X (row) is carried out in ascending order of the rank of the first dimension X; and the allocation of rank of the second dimension Y (column) is then ascending.

In an embodiment in which the permutations are carried out downstream of the array on the transmit beam-forming algorithms, the method comprises steps consisting of:
determining a set of pairs (i, j) corresponding to a routing requirement between signals upstream and signals downstream of the interconnection device, considering all the row-column intersections of the crossbar switch network;
   i. determining elementary switches of said at least one triangular matrix to be activated for said routing, said step consisting of:
   ii. organising said pairs (i, j) into rank groups having the same rank along the first dimension;
   iii. ordering said rank groups according to their rank along the first dimension;
   iv. successively allocating to each ranked group a rank along the second dimension of the array, starting with the rank along the second dimension that forms one side of the triangular matrix;
   v. within each ranked group, for each pair, transposing the pair (i, j) into the pair (i, allocated rank), activating the elementary switch of the pair (i, allocated rank), and storing the column for the allocated rank;
summing the beam-forming algorithms corresponding to said column for each allocated rank associated with a transmit beamformer;
permuting the output signals of the beamformers downstream of the crossbar switch by permuting the assignment of the algorithms to the beamformers, in accordance with the rank allocation.
   In one variant, the step of determining the elementary switches to be activated consists of:
   i. organising said pairs (i, j) into rank groups having the same rank along the first dimension;
   ii. ordering said ranked groups in ascending order of rank along the first dimension.
      In an alternative variant, the step of determining the elementary switches to be activated consists of:
   i. organising said (row, column) pairs into rank groups having the same rank along the first dimension;
   ii. ordering said ranked groups in descending order of rank along the first dimension.

FIG. 26 illustrates an example of permutations downstream of the array on the transmit beam-forming algorithms according to a third variant of the first embodiment of the disclosure, with an arrangement of elementary switches forming a triangular matrix 100a.

The example is described to establish routing requirements for line-column pairs (1,2), (1,3) and (3,1).

In a first step, the process determines a set of (row, column) pairs that correspond to the routing requirement between the inputs and outputs of the interconnection device. In this step, all the row-column intersections of the array are considered. In other words, all network intersections are taken into account to identify routing requirements between the crossbar switch inputs and the beams to be transmitted, including network intersections that do not have an elementary switch.

In the example shown in FIG. 26:
the pair (1,2) designates a routing requirement for signal Tx-1 from the first input Input1 of the crossbar switch 100a to the second beam TxBeam-2 corresponding to Algorithm “Algorithm No. 2”;
the pair (1,3) designates a routing requirement for the signal Tx-1 on the first input Input1 of the crossbar switch 100a to the third beam TxBeam-3 corresponding to “Algorithm No. 3”;
the pair (3,1) designates a routing requirement for the signal Tx-3 on the third input Input3 of the crossbar switch 100a to the first beam TxBeam-1 corresponding to “Algorithm No. 1”.

In a second step, the process determines the elementary switches to be activated. This step first involves organising the (row, column) pairs into groups having the same rank along the first dimension X of the array, that is, along the dimension of the array along which the inputs are positioned. In particular, in FIG. 26, the first dimension X is the one along which the input rows are positioned.

The following line ranked groups have been identified:
group 1 corresponding to row rank 1: {(1,2),(1,3)};
group 3 corresponding to row rank 3: {(3,1)}.

Then the row-rank groups 1 and 3 are ordered according to their row rank along the first dimension X. In particular, for the crossbar switch according to the first architecture 100a, groups 1 and 3 are ordered in decreasing order of row rank. In particular, with reference to FIG. 26, the row-rank groups 1 and 3 are ordered as follows: {group 3, group 1}, that is, {{(3, 1)}, {(1, 2), (1, 3)}}.

Then, for each group of row ranks 3 and 1, the method makes it possible to successively allocate a rank along the second dimension Y, starting with the rank along the second dimension Y forming one side of the triangular matrix carrying the elementary switches. In FIG. 26, the rank along the second dimension Y that forms one side of the triangular matrix is the column rank 3, located on the right-hand side of the triangular matrix. In this case, rank allocation along the second dimension Y is then carried out in descending order.

In one embodiment, a row counter k along the second dimension Y is initialised at 3, then progressively decremented on each allocation for successive groups of row ranks 3 and 1. Each row-rank group i is processed successively: for each connection (i, j) to be established, the association between the beam indices j and the indices k of the transmit beamformers is stored in a first table. Each transmit beamformer (k) is then configured with the sum of the beam-forming algorithms (Algorithm No. . . . ) corresponding to the directions of the beams TxBeam-j . . . , taking into account the first association table between the beam indices j and the indices k of the transmit beamformers DBF. The summation of the algorithms is possible for the same source signal Tx-j, and applies to phase-shift beamforming algorithms (complex coefficients) as well as to true-time-delay beam-forming algorithms. A second table stores the activation of the elementary switches (i, k) for all the connections to be established.

In this example, column rank k=3 is allocated to row rank group 3 {(3, 1)}. For connection (i=3, j=1), the association between beam index j=1 of TxBeam-1 and index k=3 of the transmit beamformer DBF-3 is stored in the first table. The beamformer DBF-3 is configured with the sum of the single formation algorithm, Algorithm No. 1 identified by j=1 in the first table for k=3. The activation of the elementary switch (i=3, k=3) is also stored in the second table.

Then the column rank k=2 is allocated to the row rank group 1 {(1, 2), (1, 3)}. For the connection (i=1, j=2), the association between index j=2 of TxBeam-2 and index k=2 of the transmit beamformer DBF-2 is stored in the first table. For the connection (i=1, j=3), the association between index j=3 of TxBeam-3 and index k=2 of the transmit beamformer DBF-2 is stored in the first table. The beamformer DBF-2 is configured with the sum of the beam-forming algorithms Algorithm No. 2 and Algorithm No. 3, identified by j={2, 3} in the first table for k=2. The activation of the elementary switch (i=1, k=2) is also stored in the second table.

The elementary switches are thus activated according to the second activation table: {(3, 3), (1, 2)}.

Preferably, the steps in the process for reconfiguring the telecommunications processor according to the disclosure are implemented at least in part in a processor control unit, in particular in association with a memory unit.

By convention, the figures have been described using the upper-left corner as the origin for the row and column ranks. However, another point of the row-column array may be chosen as the origin, and the example descriptions can readily be adapted accordingly.

1. A telecommunications processor comprising a reconfigurable non-blocking interconnection device, configured to receive, at its inputs, signals originating from one or more receive antennas and to deliver said signals, via its outputs, to one or more transmit antennas;
the interconnection device comprising a crossbar switch forming a two-dimensional array of N rows and P columns, the inputs of the crossbar switch being located along a first dimension of the array, the outputs of the crossbar switch being located along a second dimension of the array;
the crossbar switch comprising a number of elementary switches smaller than the number of row-column intersections of the two-dimensional network, for routing said signals from the inputs to the outputs;
the elementary switches being arranged on the network at row-column intersections to form at least one triangular matrix, such that all the line-column intersections in the said at least one triangular matrix comprise an elementary switch that can be activated, and such that all or some of the line-column intersections situated outside the said at least one triangular matrix do not comprise an elementary switch.

2. The telecommunications processor according to claim in which the interconnection device is coupled to a permutation device enabling the input or output signals of said at least one triangular matrix to be permuted.

3. The telecommunications processor according to claim 2, comprising receive beamformers associated with beamforming algorithms, and wherein said permutation device is configured to permute one or more beamforming algorithms between the beamformers, so as to permute said signals upstream of said at least one triangular matrix, depending on the routing requirement between the upstream signals and the downstream signals of the configurable interconnection device.

4. The telecommunications processor according to claim 2, comprising transmit beamformers associated with beam-forming algorithms, and wherein said permutation device is configured to permute one or more beamforming algorithms between the beamformers, so as to permute said signals downstream of said at least one triangular matrix, depending on the routing requirement between the upstream signals and the downstream signals of the configurable interconnection device.

5. The telecommunications processor according to claim 1, wherein the two-dimensional array of N rows and P columns forms a square array with N=P or a rectangular array with N≠P.

6. The telecommunications processor according to claim 1, wherein said elementary switches forming at least one triangular matrix are 1×1 switches or 2×1 switches.

7. The telecommunications processor according to claim 1, wherein said elementary switches forming at least one triangular matrix are 2×2 switches configured to selectively interconnect a first input along the first dimension or a second input along the second dimension with a first output along the first dimension and independently with a second output along the second dimension.

8. The telecommunications processor according to claim 7, in which the said elementary switches on the diagonal of the said at least one triangular matrix are connected successively to one another, by connecting the row output of each switch to the column input of the next switch on the diagonal.

9. The telecommunications processor according to claim 2, wherein the permutation device comprises a switch connected upstream of the crossbar switch, said switch being configured to distribute said signals among the inputs of the crossbar switch according to the routing requirement between the upstream signals and the downstream signals of the configurable interconnection device.

10. The method of configuring a telecommunications processor according to claim 3, said method comprising, for signal routing, steps consisting of:
determining a set of pairs (i, j) corresponding to a routing requirement between signals upstream and signals downstream of the interconnection device, considering all the line-column intersections of the crossbar switch network,
determining elementary switches of said at least one triangular matrix to be activated for said routing, said step consisting of:
organising said pairs (i, j) into rank groups having the same rank along the first dimension;
determining an extremum rank in the second dimension for each rank group;
ordering said rank groups according to their extremum rank along the second dimension;
successively allocating to each ranked group a rank along the first dimension of the array, following the order obtained from said scheduling step, starting with the rank along the first dimension that forms one side of the triangular matrix;
for each group of ranks, transposing each pair (i, j) into a pair (allocated rank, j), and activating the elementary switch of said pair (allocated rank, j);
permuting the signals at the input of the crossbar switch, in accordance with the rank allocation.

11. The method according to claim 10, wherein the step of determining the elementary switches to be activated comprises:
organising said pairs (i, j) into rank groups having the same rank along the first dimension;
determining a minimum rank in the second dimension for each rank group;
ordering said rank groups in ascending order of minimum rank along the second dimension.

12. The method according to claim 10, wherein the step of determining the elementary switches to be activated comprises:
organising said pairs (i, j) into rank groups having the same rank along the first dimension;
determining a maximum rank in each rank group according to the second dimension;
ordering said rank groups in descending order of maximum rank along the second dimension.

13. The method of configuring a telecommunications processor according to claim 4, said method comprising, for signal routing, steps consisting of:
determining a set of pairs (i, j) corresponding to a routing requirement between signals upstream and signals downstream of the interconnection device, considering all the line-column intersections of the crossbar switch array;
determining elementary switches of said at least one triangular matrix to be activated for said routing, said step consisting of:
organising said pairs (i, j) into rank groups having the same rank along the first dimension;
ordering said rank groups according to their rank along the first dimension;
successively allocating to each ranked group a rank along the second dimension of the array, starting with the rank along the second dimension that forms one side of the triangular matrix;
within each ranked group, for each pair, transposing the pair (i, j) into the pair (i, allocated rank), activating the elementary switch of the pair (i, allocated rank), and storing the rank j along the second dimension for the allocated rank;
summing the beam-forming algorithms corresponding to the ranks along the second dimension that are stored for the same allocated rank associated with a transmit beamformer;
permuting the output signals of the beamformers downstream of the crossbar switch by permuting the assignment of the algorithms to the beamformers, in accordance with the rank allocation.

14. The method according to claim 13, in which the step of determining the elementary switches to be activated consists of:
organising said pairs (i, j) into rank groups having the same rank along the first dimension;
ordering said ranked groups in ascending order of rank along the first dimension.

15. The method according to claim 13, in which the step of determining the elementary switches to be activated consists of:
organising said pairs (i, j) into rank groups having the same rank along the first dimension;
ordering said ranked groups in descending order of rank along the first dimension.
